(19) United States
(12) Patent Application Publication
(10) Pub. No.: US 2020/0003245 A1
(43) Pub. Date: Jan. 2, 2020

(54) Fastener With Transition Zone And Method Of Use

(71) Applicant: SR Systems, LLC, Tuscaloosa, AL (US)

(72) Inventors: Steve Zimmerman, Linden, AL (US); Van T. WALWORTH, Rockwood, TN (US); Scott DRUMMOND, Tuscaloosa, AL (US)

(21) Appl. No.: 16/570,151

(22) Filed: Sep. 13, 2019

Related U.S. Application Data
(62) Division of application No. 16/152,844, filed on Oct. 5, 2018.
Application No. 16/152,844 is a continuation-in-part of application No. 15/223,179, filed on Jul. 29, 2016, now abandoned.
(60) Provisional application No. 62/199,274, filed on Jul. 31, 2015.
(60) Provisional application No. 62/208,158, filed on Aug. 21, 2015.
(60) Provisional application No. 62/388,554, filed on Feb. 2, 2016.

(51) Int. Cl. F16B 15/06; F16B 25/00

(52) U.S. Cl. CPC F16B 15/06; F16B 25/0063

(57) ABSTRACT

An improved fastener for securing a first building component to a second building component is provided. The fastener includes a head, a shank, and a tip. The shank is connected to the head and extends along a longitudinal axis to the tip. The shank includes an upper shank portion, a lower shank portion, and a transition zone. The upper shank portion is located adjacent to the head. The lower shank portion is spaced from the upper shank portion and is located adjacent to the tip. The transition zone is positioned longitudinally between the upper shank portion and the lower shank portion. The transition zone is longitudinally spaced from the head by a pre-determined distance. The pre-determined distance is associated with a thickness of the first building component such that the transition zone is aligned with a joint between the first and second building components.

### CROSS REFERENCE TO RELATED APPLICATIONS

This application is a divisional of U.S. patent application Ser. No. 16/152,844, filed Oct. 5, 2018, which is a continuation-in-part of U.S. patent application Ser. No. 15/223,179, filed Jul. 29, 2016 (now abandoned), which claims the benefit of U.S. Provisional Application No. 62/199,274, filed Jul. 31, 2015; U.S. Provisional Application No. 62/208,158, filed Aug. 21, 2015; and U.S. Provisional Application No. 62/388,554, filed Feb. 2, 2016. The entire disclosure of each of the above referenced applications is incorporated herein by reference.

### FIELD

The subject disclosure generally relates to fasteners. By way of example and without limitation, such fasteners may be used in the construction industry for securing multiple building components to one another.

### BACKGROUND

This section provides background information related to the present disclosure and is not necessarily prior art.

There are many types of fasteners for securing two or more pieces of wood or wood-like building components to one another. The construction industry has a variety of nail and screw fasteners designed for various specific applications. The wood or wood-like building components may be substrate plywood sheathing or decking material, board lumber, framing material, or any one of other similar construction components.

Many fasteners are very simple devices comprised of a simple head portion, a simple shank portion, and a standard pointed tip portion. Other fastening devices are more complex being comprised of a specialized head portion, intricate shank portion features, and/or variations of point portion tips. Many of the complex fastening devices have so many different sizes and lengths for a user to choose from, that it is difficult for the user to match the correct fastener option to the application, which results in substandard installations.

Examples of nail-like fasteners are disclosed in U.S. Pat. No. 6,758,018 entitled “Power Driven Nails for Sheathing Having Enlarged Diameter Heads for Enhanced Retention and Method”, which issued to Edward Sutt, Jr. on Jul. 6, 2004; U.S. Pat. No. 7,374,384 entitled “Fasteners for Securing Pallet Members Together”, which issued to Edward Sutt, Jr. on May 20, 2008; U.S. Pat. No. 7,395,925 entitled “Pallet Nail with Enlarged Head”, which issued to Edward Sutt, Jr. on Jul. 8, 2008; and U.S. Pat. No. 8,794,893 entitled “Fastening Pin and Manufacturing Method Thereof”, which issued to Yasunori Aihara, et al, on Aug. 5, 2014. The shank portions of the nail-like fasteners disclosed in these references fail to include a deliberate delineation marking which portion of the shank is designed to be located at the joint between two construction components.

Examples of screw-like fasteners are disclosed in U.S. Pat. No. 9,163,654 entitled “Screw for Composite/Plastic Materials”, which issued to Peter Barenski, Jr., et al, on Oct. 20, 2015 and U.S. Patent Application Publication No. 2007/0204552 entitled “Plastic Composite Deck Screw”, which published on Sep. 6, 2007 naming Daniel Onofrio as the sole inventor. The shank portions of the screw-like fasteners disclosed in these references also fail to include a deliberate delineation marking which portion of the shank is designed to be located at the joint between two construction components.

### SUMMARY

This section provides a general summary of the disclosure, and is not a comprehensive disclosure of its full scope or all of its features.

In accordance with one aspect of the present disclosure, an improved fastener for securing a first building component to a second building component is provided. The fastener includes a head, a shank, and a tip. The head has a head diameter and the shank has a shank diameter that is less than the head diameter. The shank is connected to the head and extends along a longitudinal axis to the tip. The shank includes an upper shank portion, a lower shank portion, and a transition zone. The upper shank portion is located adjacent to the head. The lower shank portion is spaced from the upper shank portion and is located adjacent to the tip. The transition zone is positioned longitudinally between the upper shank portion and the lower shank portion. The transition zone is longitudinally spaced from the head by a pre-determined distance. The pre-determined distance is associated with a thickness of the first building component such that the transition zone is aligned with a joint between the first and second building components. Advantageously, the fastener of the present disclosure overcomes the short-comings of the known nail-like and screw-like fasteners discussed above.

In accordance with another aspect of the present disclosure, a method of selecting a fastener and a building component is provided. The method includes the steps of placing the fastener adjacent and transverse to the building component, aligning the head of the fastener with an upper surface of the building component, and determining whether the fastener is appropriate for use with the building component by visually identifying whether the transition zone provided on the shank of the fastener is aligned with a lower surface of the building component. In accordance with the method, the fastener is determined to be appropriate for use with the building component if the transition zone of the fastener is aligned with the lower surface of the building component. By contrast, the fastener is determined to be inappropriate for use with the building component if the transition zone of the fastener is above or below the lower surface of the building component.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side elevation view of a known nail-like fastener with a smooth shank;

FIG. 2 is a side elevation view of a known nail-like fastener with multiple retention rings on the shank that increase in diameter moving toward the head of the nail-like fastener;

FIG. 3 is a side elevation view of a known nail-like fastener with flute-like spirals on the shank;

FIG. 4 is a side elevation view of a known nail-like fastener with helically extending spirals on the shank;

FIG. 5 is a side perspective view of a known nail-like fastener with an upper shank portion that has flute-like spirals, a middle shank portion that is smooth, and a lower shank portion that has retention rings that increase in diameter moving toward the head of the nail-like fastener;

FIG. 6 is a side elevation view of an exemplary fastener constructed in accordance with the subject disclosure that includes a transition zone on the shank;

FIG. 7 is a side perspective view of the exemplary fastener shown in

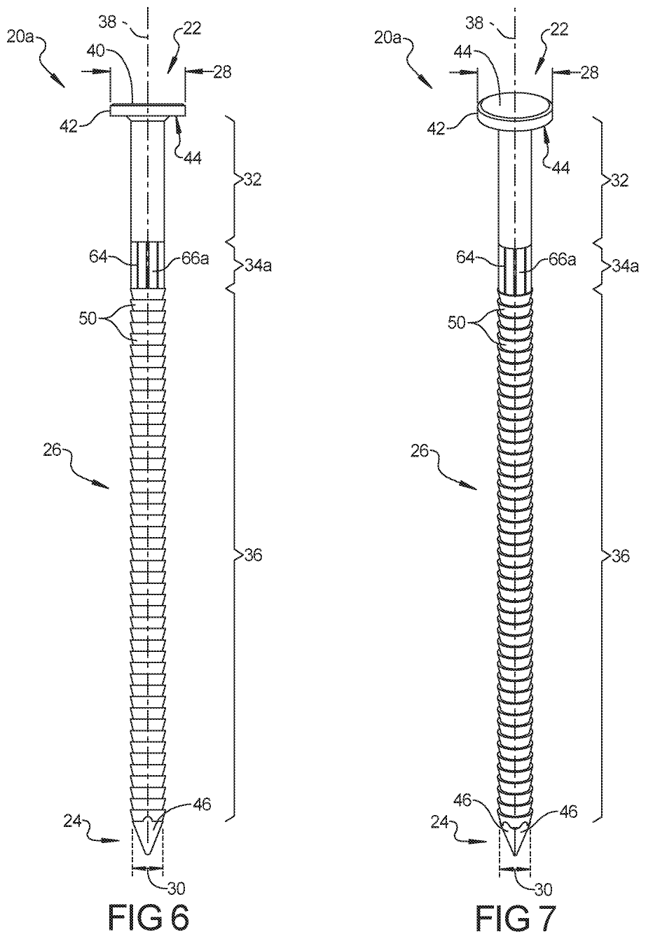

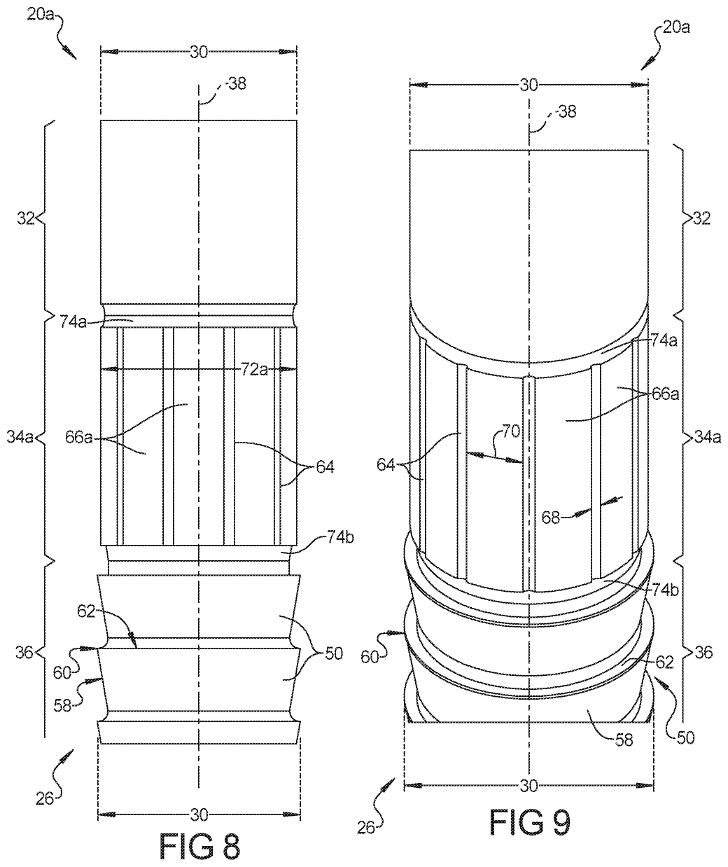

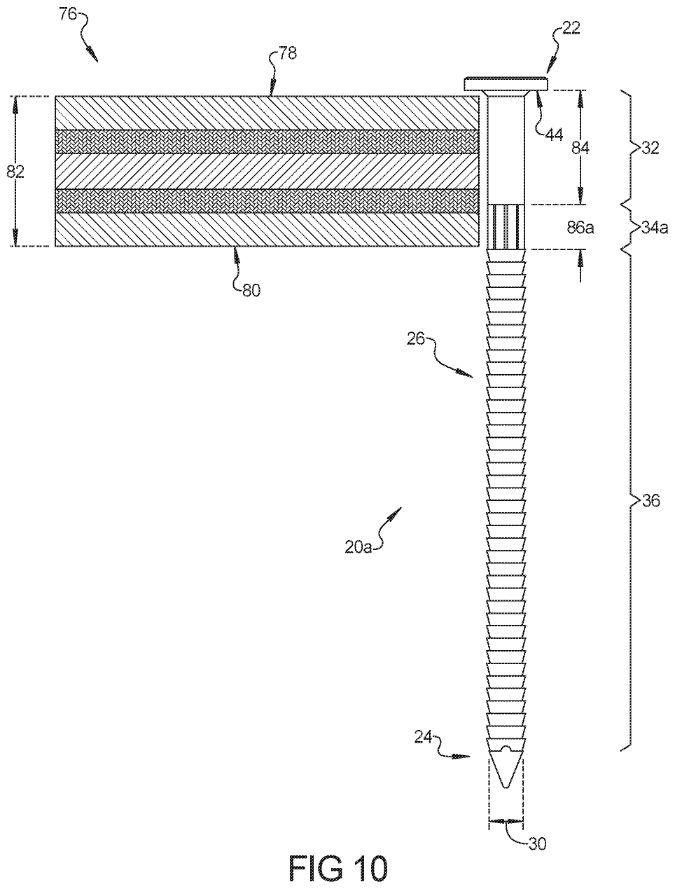

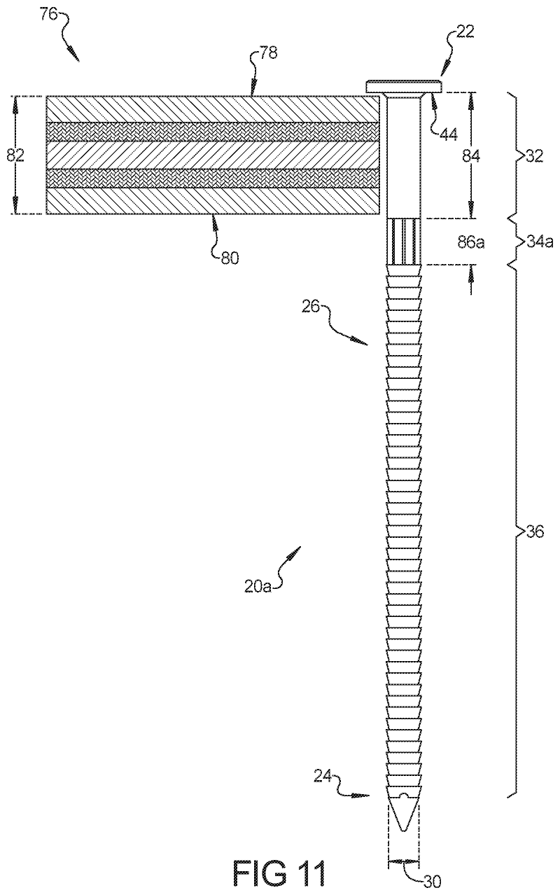

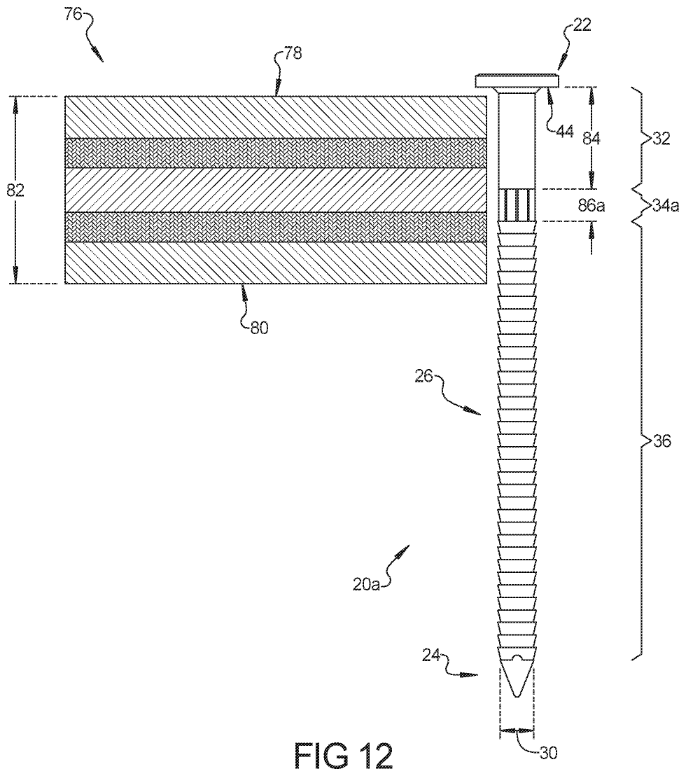

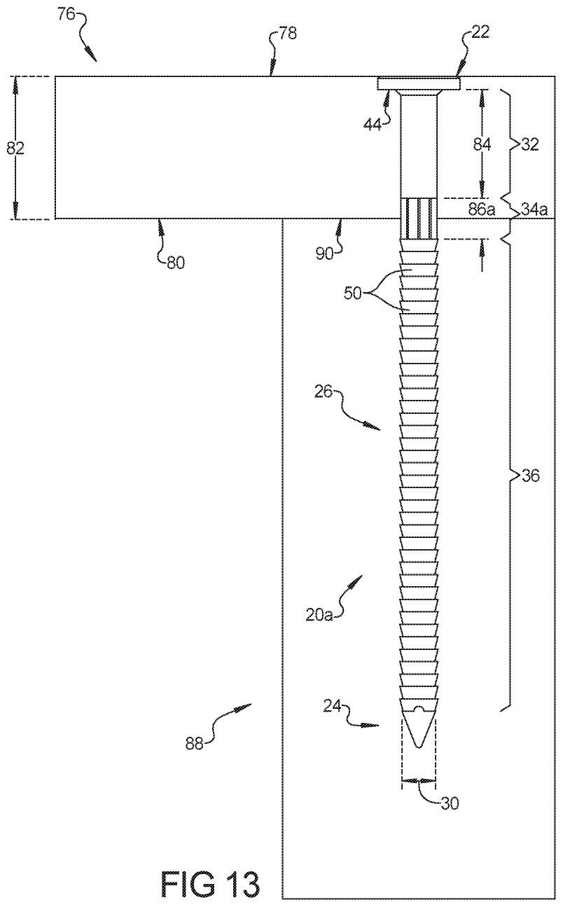

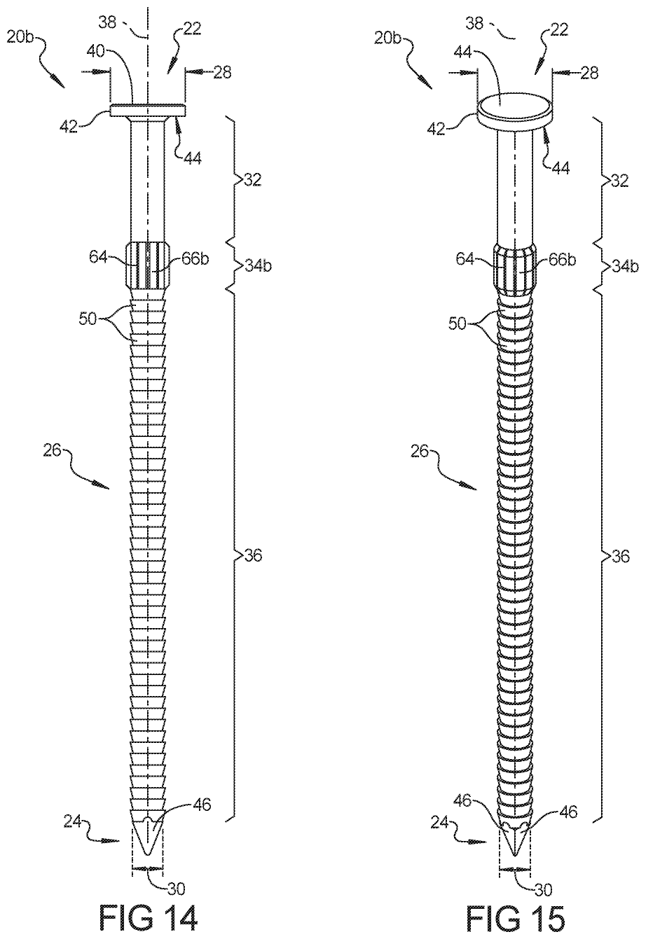

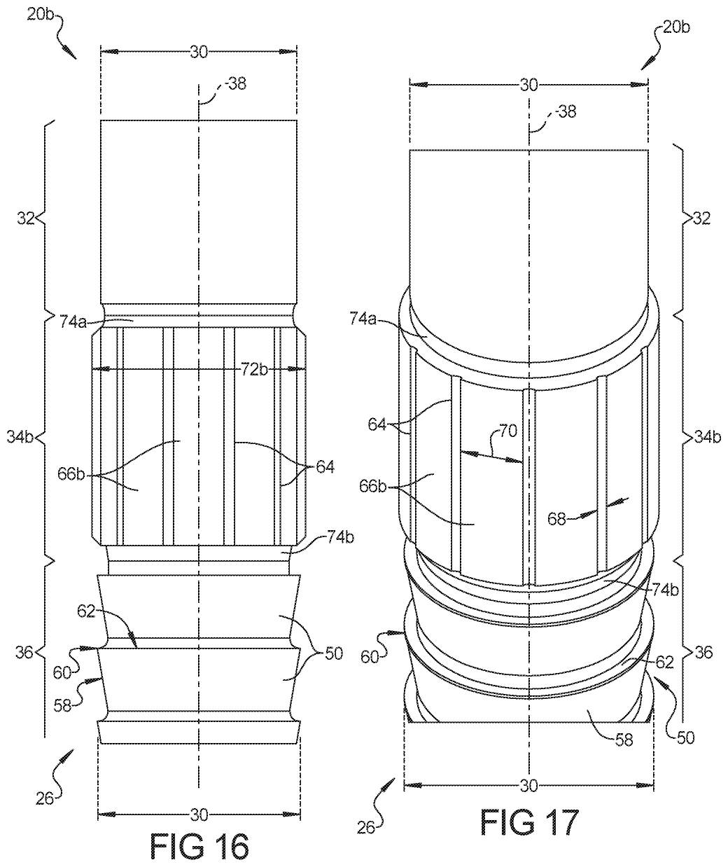

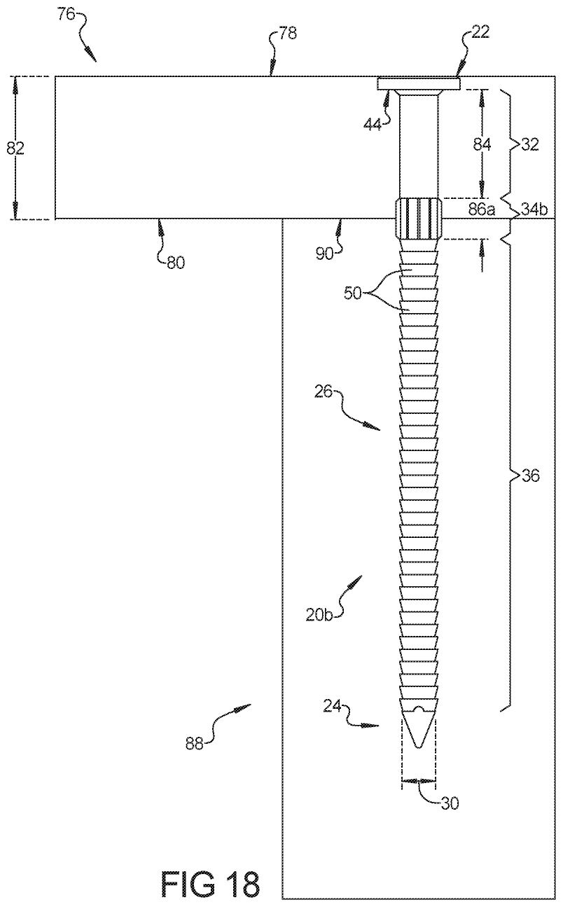

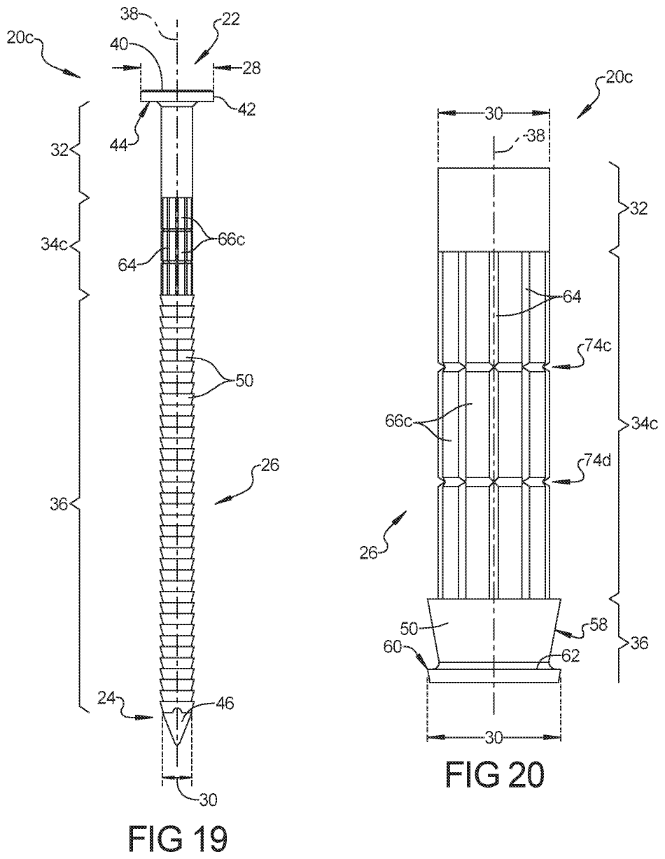

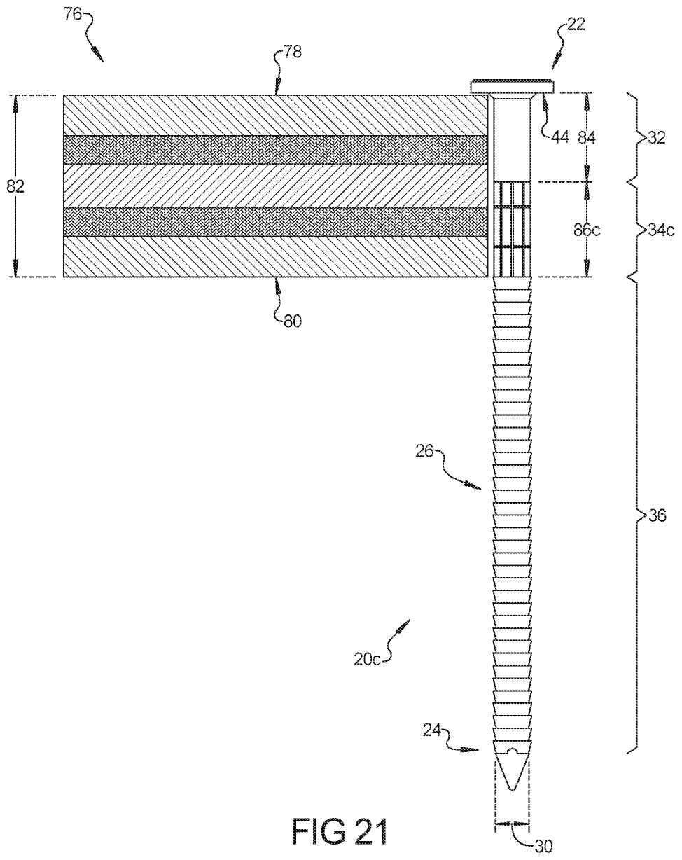

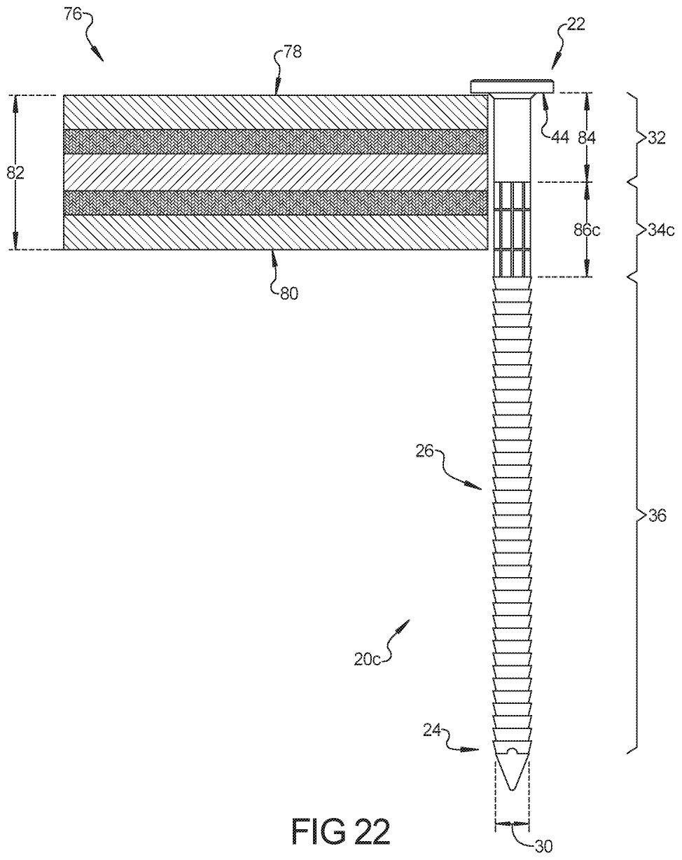

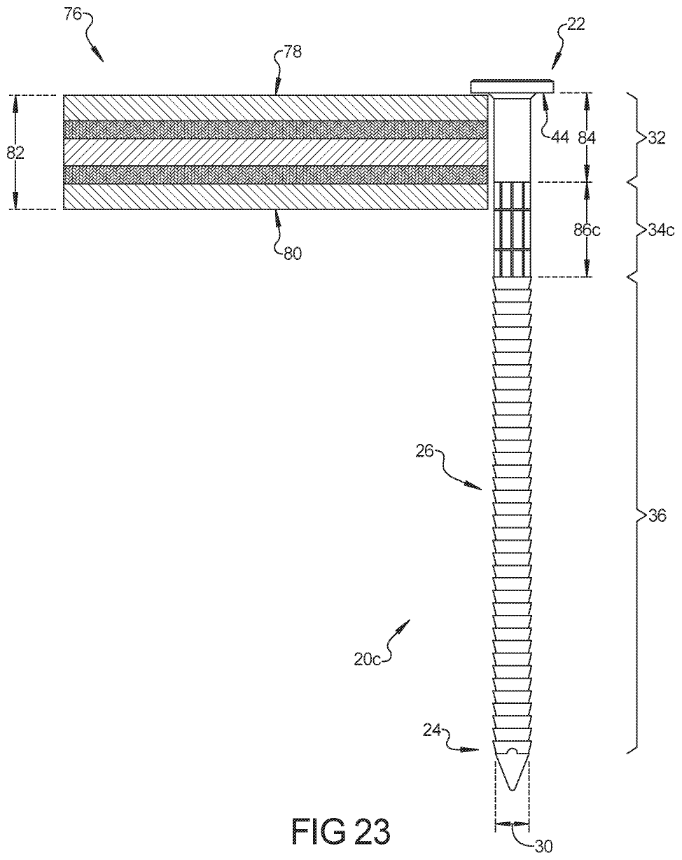

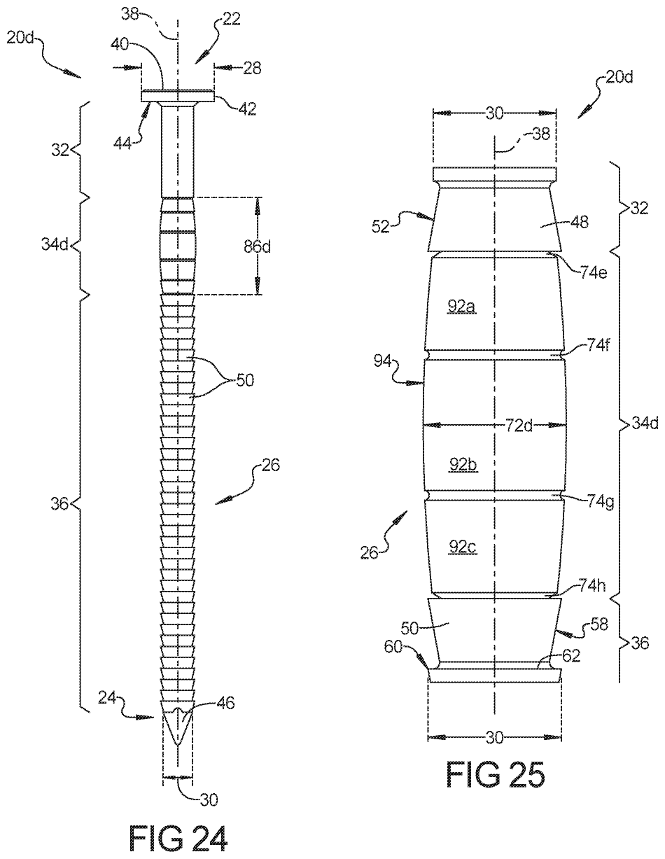

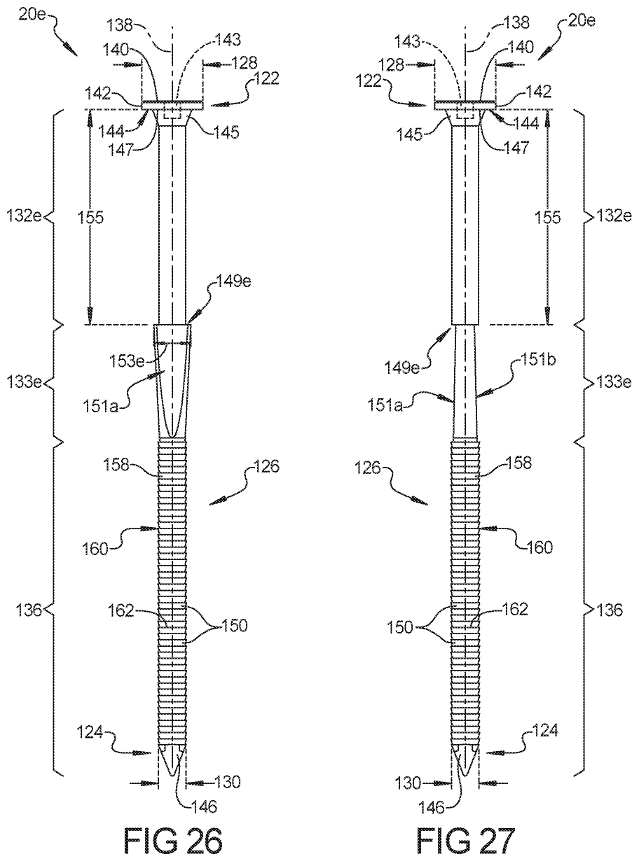

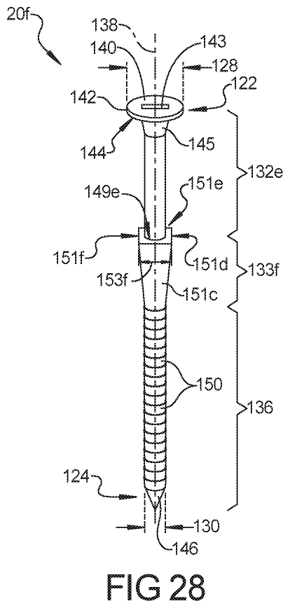

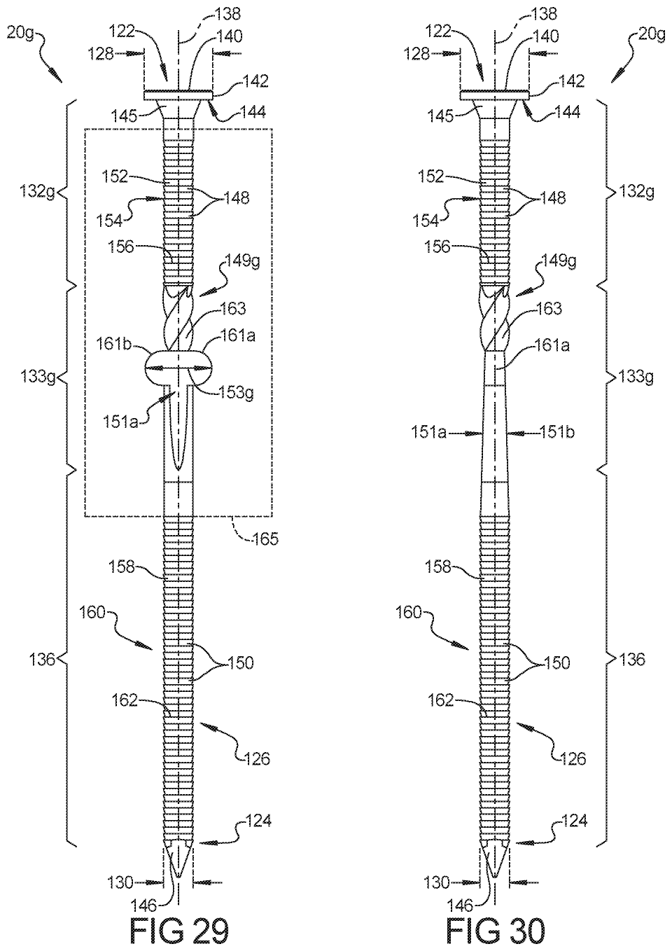

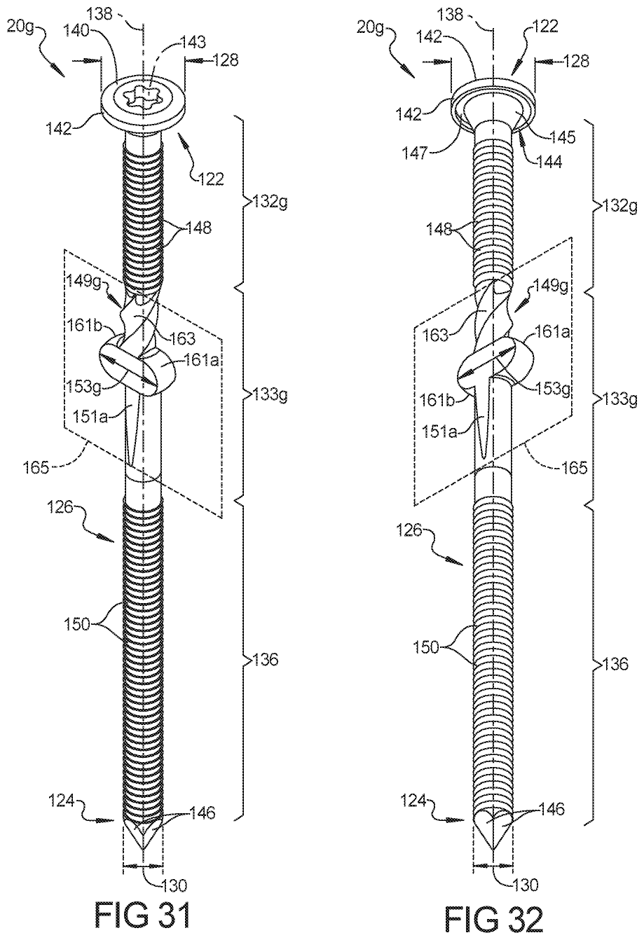

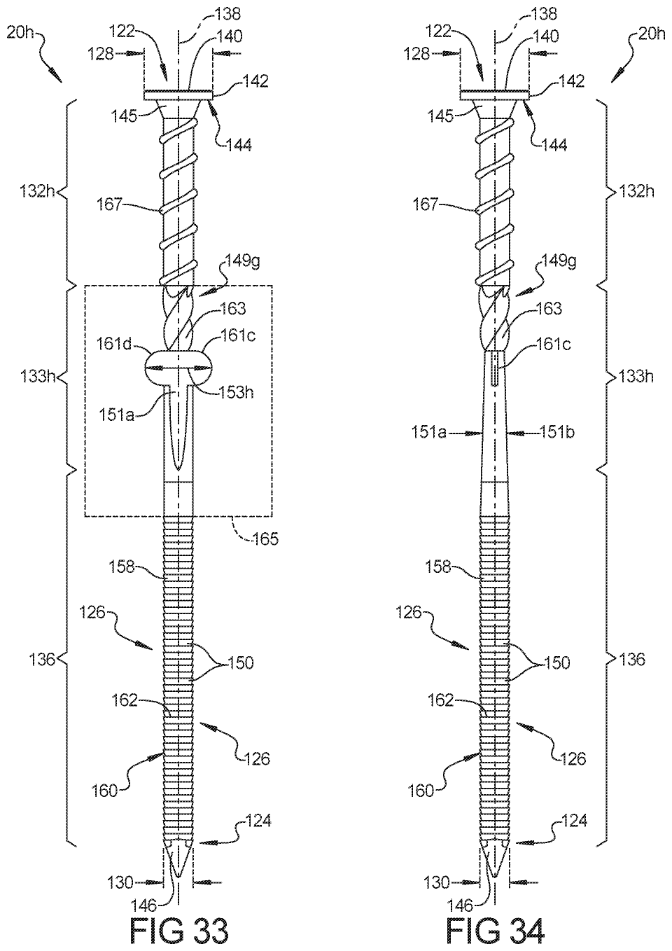

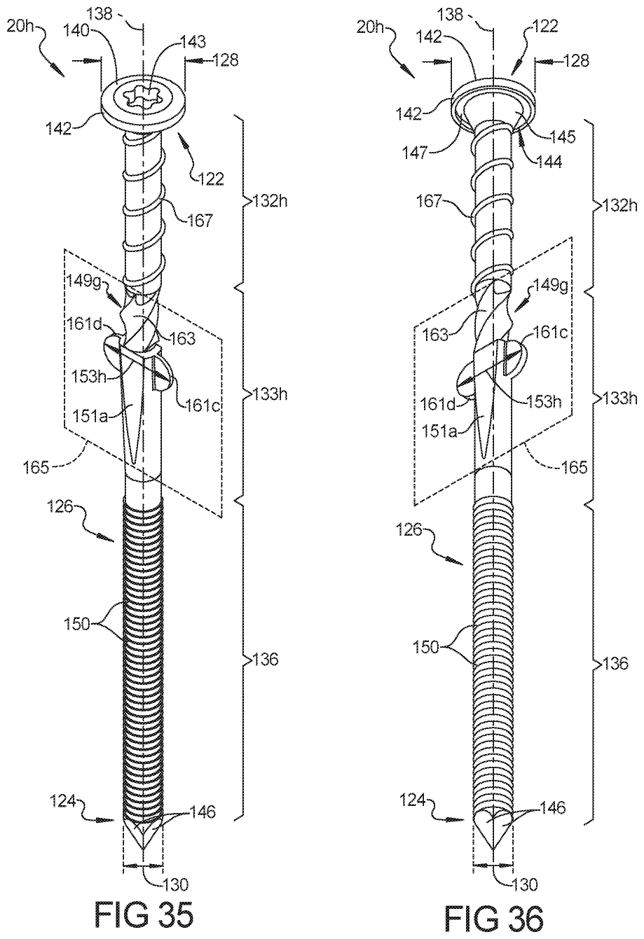

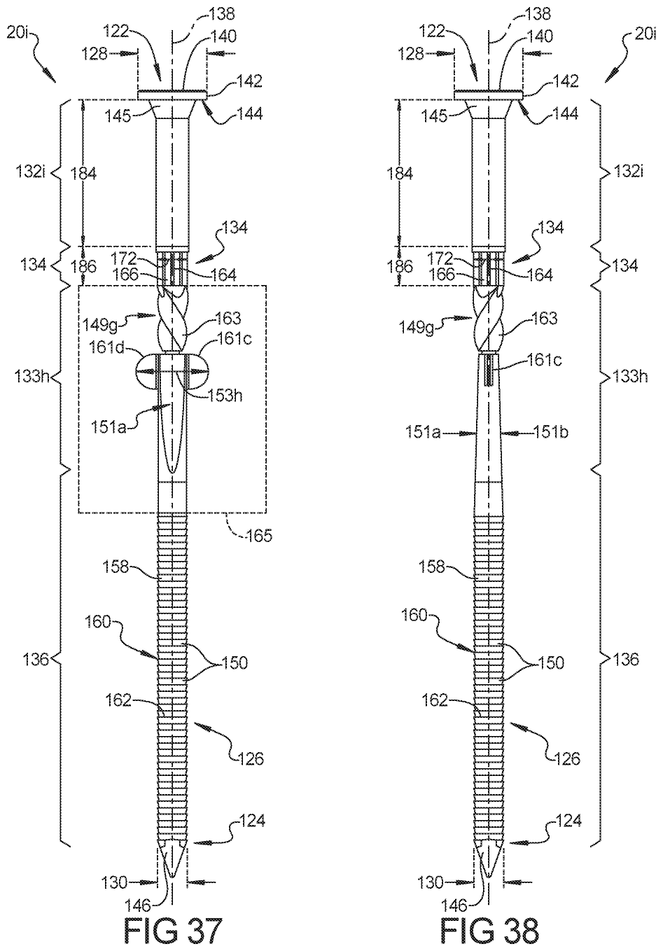

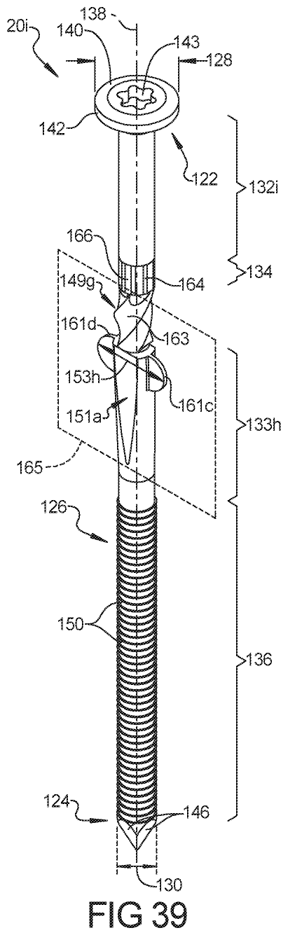

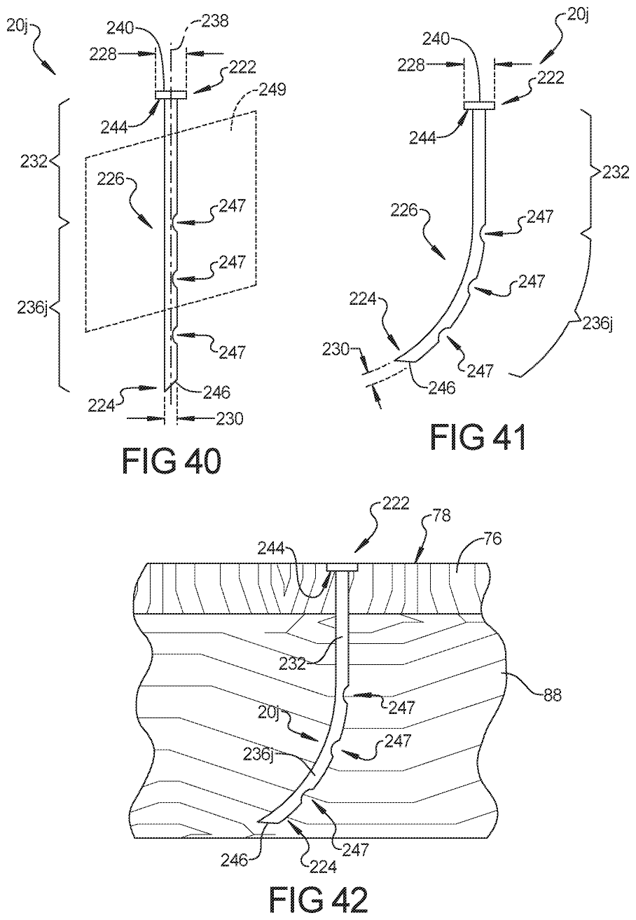

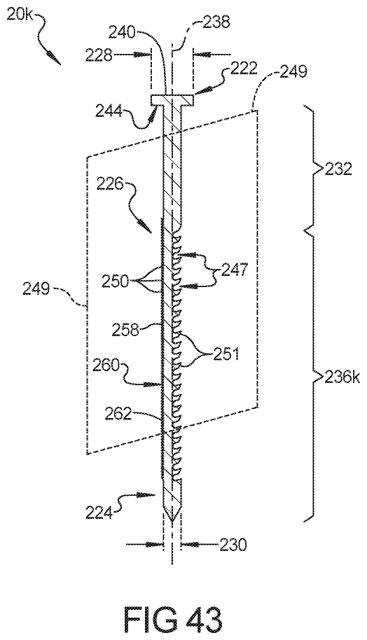

FIG. 6;

FIG. 8 is an enlarged side elevation view of the transition zone of the exemplary fastener shown in FIG. 6;

FIG. 9 is an enlarged side perspective view of the transition zone of the exemplary fastener shown in FIG. 6;

FIG. 10 is a side elevation view of the exemplary fastener illustrated in FIG. 6 that is shown next to an exemplary building component where the transition zone of the exemplary fastener is aligned with a lower surface of the exemplary building component;

FIG. 11 is a side elevation view of the exemplary fastener illustrated in FIG. 6 that is shown next to an exemplary building component where the transition zone of the exemplary fastener is below the lower surface of the exemplary building component;

FIG. 12 is a side elevation view of the exemplary fastener illustrated in FIG. 6 that is shown next to an exemplary building component where the transition zone of the exemplary fastener is above the lower surface of the exemplary building component;

FIG. 13 is a side elevation view of the exemplary fastener illustrated in FIG. 6 that is shown embedded in two exemplary building components;

FIG. 14 is a side elevation view of another exemplary fastener constructed in accordance with the subject disclosure that includes a transition zone on the shank with radially projecting longitudinal ribs;

FIG. 15 is a side perspective view of the exemplary fastener shown in

FIG. 14;

FIG. 16 is an enlarged side elevation view of the transition zone of the exemplary fastener shown in FIG. 14;

FIG. 17 is an enlarged side perspective view of the transition zone of the exemplary fastener shown in FIG. 14;

FIG. 18 is a side elevation view of the exemplary fastener illustrated in FIG. 14 that is shown embedded in two exemplary building components;

FIG. 19 is a side elevation view of another exemplary fastener constructed in accordance with the subject disclosure that includes an elongated transition zone on the shank;

FIG. 20 is an enlarged side elevation view of the elongated transition zone of the exemplary fastener shown in FIG. 19;

FIG. 21 is a side elevation view of the exemplary fastener illustrated in FIG. 19 that is shown next to an exemplary building component where the elongated transition zone of the exemplary fastener is aligned with a lower surface of the exemplary building component;

FIG. 22 is another side elevation view of the exemplary fastener illustrated in FIG. 19 that is shown next to an exemplary building component where the elongated transition zone of the exemplary fastener is aligned with a lower surface of the exemplary building component;

FIG. 23 is another side elevation view of the exemplary fastener illustrated in FIG. 19 that is shown next to an exemplary building component where the elongated transition zone of the exemplary fastener is aligned with a lower surface of the exemplary building component;

FIG. 24 is a side elevation view of another exemplary fastener constructed in accordance with the subject disclosure that includes a bulbous transition zone on the shank;

FIG. 25 is an enlarged side elevation view of the bulbous transition zone of the exemplary fastener shown in FIG. 24;

FIG. 26 is a front elevation view of another exemplary fastener constructed in accordance with the subject disclosure that includes a shank with an anti-rotation portion having two faces;

FIG. 27 is a side elevation view of the exemplary fastener shown in

FIG. 26;

FIG. 28 is a side perspective view of another exemplary fastener constructed in accordance with the subject disclosure that includes a shank with an anti-rotation portion having four faces;

FIG. 29 is a front elevation view of another exemplary fastener constructed in accordance with the subject disclosure that includes a shank with an anti-rotation portion having two faces and two ears;

FIG. 30 is a side elevation view of the exemplary fastener shown in FIG. 29;

FIG. 31 is a top perspective view of the exemplary fastener shown in FIG. 29;

FIG. 32 is a bottom perspective view of the exemplary fastener shown in FIG. 29;

FIG. 33 is a front elevation view of another exemplary fastener constructed in accordance with the subject disclosure that includes a shank with an anti-rotation portion and an upper shank portion that is threaded;

FIG. 34 is a side elevation view of the exemplary fastener shown in FIG. 33;

FIG. 35 is a top perspective view of the exemplary fastener shown in FIG. 33;

FIG. 36 is a bottom perspective view of the exemplary fastener shown in FIG. 33;

FIG. 37 is a front elevation view of another exemplary fastener constructed in accordance with the subject disclosure that includes a shank with an anti-rotation portion and a transition zone;

FIG. 38 is a side elevation view of the exemplary fastener shown in

FIG. 37;

FIG. 39 is a side perspective view of the exemplary fastener shown in

FIG. 37;

FIG. 40 is a side elevation view of another exemplary fastener constructed in accordance with the subject disclosure that includes a shank with relief cuts;

FIG. 41 is a side elevation view of the exemplary fastener shown in FIG. 40 where the shank has become bent as a result of being driven into one or more building components;

FIG. 42 is a side elevation view of the exemplary fastener illustrated in FIG. 40 that is shown embedded in two exemplary building components;

FIG. 43 is a side cross-sectional view of another exemplary fastener constructed in accordance with the subject disclosure that includes a shank with relief cuts and a plurality of retention rings;

FIG. 44 is a side elevation view of another exemplary fastener constructed in accordance with the subject disclosure that includes a shank with a helical bend;

FIG. 45 is a side elevation view of another exemplary fastener constructed in accordance with the subject disclosure that includes a bridge portion and two shanks with helical bends;

FIG. 46 is a partial side perspective view of an exemplary tip and lower shank portion of a fastener that is constructed in accordance with the subject disclosure where the tip includes four beveled blades of varying lengths;

FIG. 47 is an enlarged side perspective view of the exemplary tip of the fastener shown in FIG. 46;

FIG. 48 is a bottom elevation view of the exemplary tip of the fastener shown in FIG. 46;

FIG. 49 is a side perspective view of another exemplary fastener constructed in accordance with the subject disclosure where the tip includes four blades having a cross-like cross-section; and

FIG. 50 is a bottom cross-sectional view of the tip of the exemplary fastener shown in FIG. 49.

### DETAILED DESCRIPTION

Referring to the Figures, wherein like numerals indicate corresponding parts throughout the several views, several fasteners 20a-20m constructed in accordance with the subject invention are illustrated.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

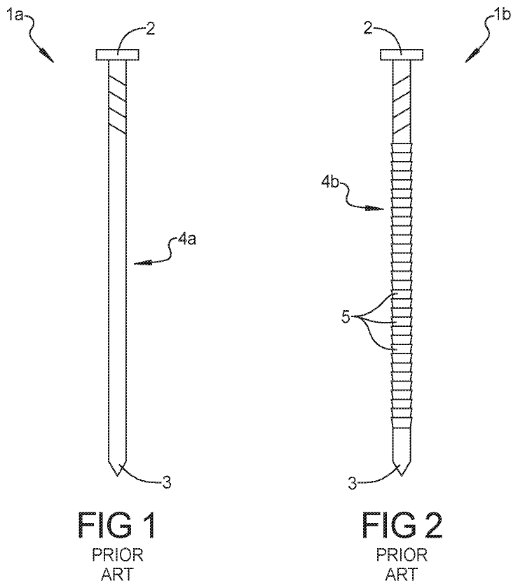

Referring to FIGS. 1-5, several known nail-like fasteners 1a-e are illustrated. Each of these nail-like fasteners 1a-e extends longitudinally between a head 2 and a tip 3. Each of the nail-like fasteners 1a-e also includes a shank 4a-e disposed between the head 2 and the tip 3. It should generally be appreciated that the head 2 of each of the nail-like fasteners 1a-e illustrated in FIGS. 1-5 is larger in diameter than the shank 4a-e of the nail-like fasteners 1a-e and the tip 3 of each of the nail-like fasteners 1a-e is generally pointed. The shank 4a of the nail-like fastener 1a shown in FIG. 1 is smooth and has a cylindrical shape. As such, the nail-like fastener 1a shown in FIG. 1 has the configuration of a traditional nail. The shank 4b of the nail-like fastener 1b shown in FIG. 2 generally has a cylindrical shape and includes multiple retention rings 5. The multiple retention rings 5 extend along only a portion of the shank 4b with the shank 4b being smooth adjacent to the head 2 and the tip 3. Each of the multiple retention rings 5 is frusto-conical in shape and increase in diameter moving toward the head 2 of the nail-like fastener 1b.

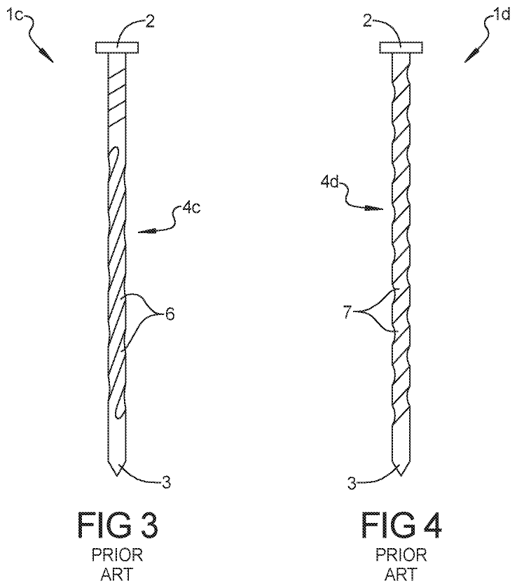

The shank 4c of the nail-like fastener 1c shown in FIG. 3 generally has a cylindrical shape and includes flute-like spirals 6. The flute-like spirals 6 may be cut into the shank 4c and extend along only a portion of the shank 4c with the shank 4c being smooth adjacent to the head 2 and the tip 3. The shank 4d of the nail-like fastener 1d shown in FIG. 4 generally has a cylindrical shape and includes helically extending spirals 7. The helically extending spirals 7 may be cut into the shank 4d and extend in a helical fashion along only a portion of the shank 4d with the shank 4d being smooth adjacent to the head 2 and the tip 3. In this way, the helically extending spirals 7 of the nail-like fastener 1d may resemble the shape of a drill bit.

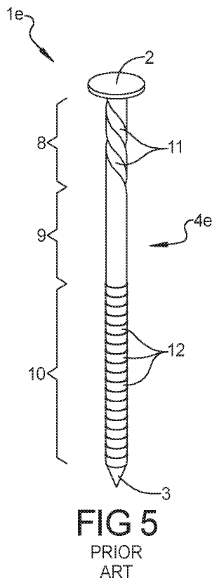

The shank 4e of the nail-like fastener 1e shown in FIG. 5 is generally cylindrical and includes an upper shank portion 8, a middle shank portion 9, and a lower shank portion 10. The upper shank portion 8 is disposed adjacent to the head 2 of the nail-like fastener 1e and the lower shank portion 10 is disposed adjacent to the tip 3 of the nail-like fastener 1e. The upper and lower shank portions 8, 10 are spaced from one another by the middle shank portion 9, which is disposed between the upper shank portion 8 and the lower shank portion 10. The upper shank portion 8 of the nail-like fastener 1e shown in FIG. 5 is provided with flute-like spirals 11 that are similar to those found on the shank 4c of the nail-like fastener 1c shown in FIG. 3. The middle shank portion 9 of the nail-like fastener 1e shown in FIG. 5 is smooth like the shank 4a of the nail-like fastener 1a shown in FIG. 1. The lower shank portion 10 of the nail-like fastener 1e shown in FIG. 5 is provided with multiple retention rings 12 that are similar to those found on the shank 4b of the nail-like fastener 1b shown in FIG. 2. As such, the multiple retention rings 12 on the lower shank portion 10 increase in diameter moving toward the head 2 of the nail-like fastener 1e shown in FIG. 5.

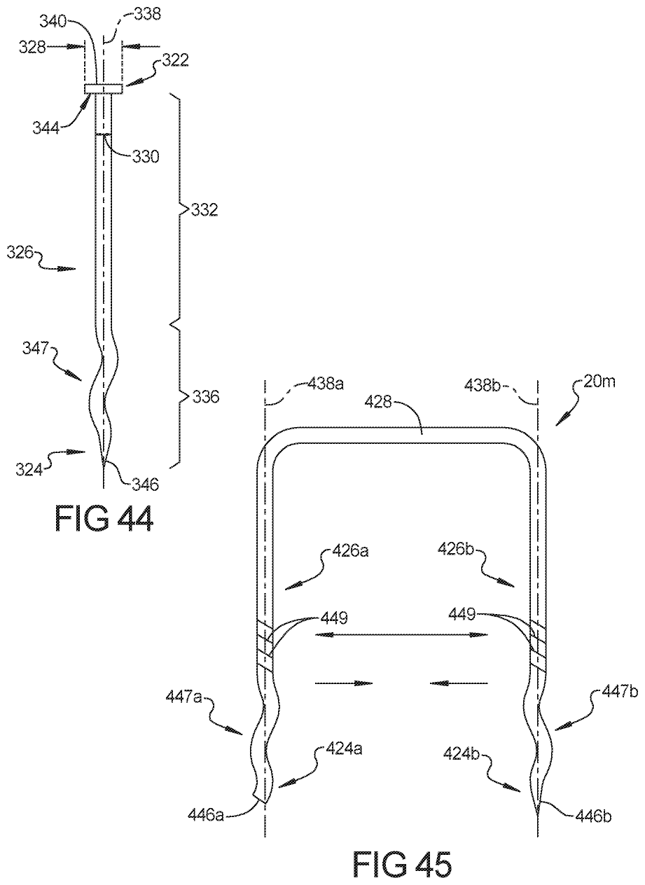

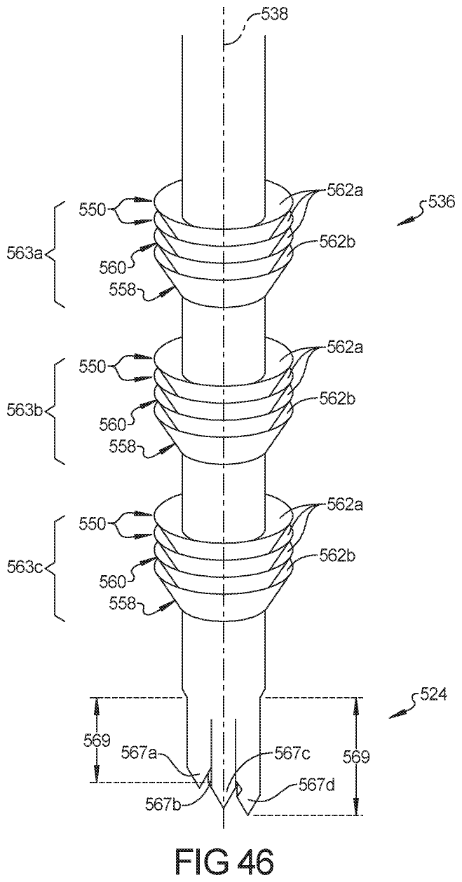

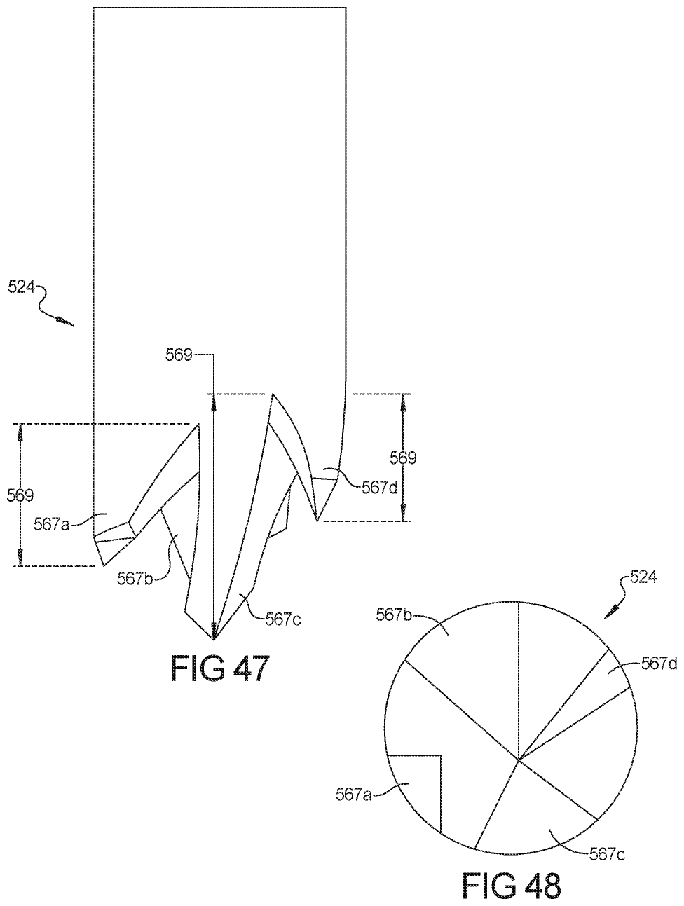

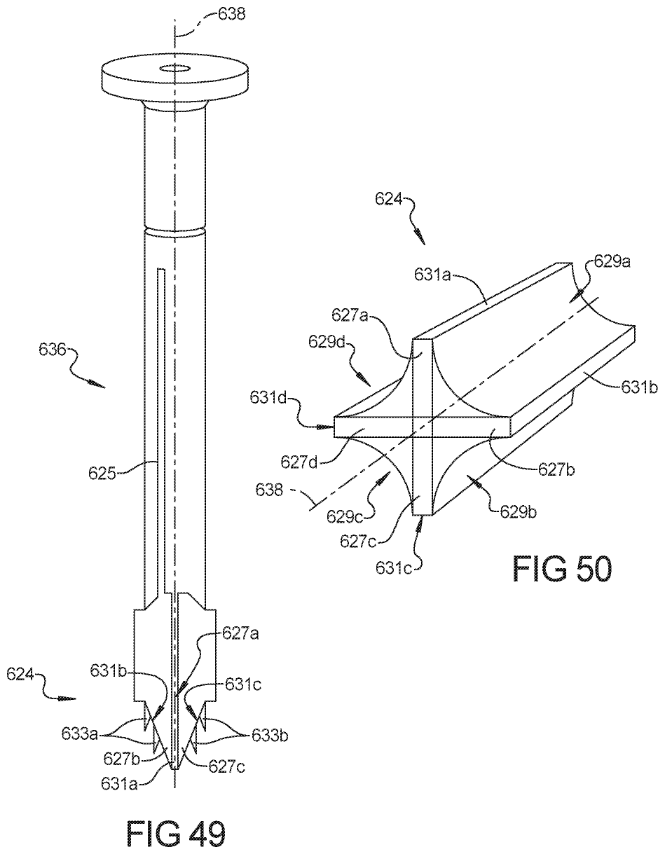

With reference to FIGS. 6-13, a fastener 20a constructed in accordance with the present disclosure is illustrated. The fastener 20a extends longitudinally between a head 22 and a tip 24. The fasteners 20a also includes a shank 26 disposed between the head 22 and the tip 24. As best seen in FIGS. 6 and 7, the head 22 of the fastener 20a has a head diameter 28 and the shank 26 of the fastener 20a has a shank diameter 30 that is smaller than the head diameter 28. The tip 24 of the fastener 20a tapers from the shank diameter 30 to a point (i.e. the tip 24 of the fastener 20a is pointed). The shank 26 of the fastener 20a shown in FIGS. 6-13 is generally cylindrical in shape and includes an upper shank portion 32, a transition zone 34a, and a lower shank portion 36. The upper shank portion 32 is disposed adjacent to the head 22 of the fastener 20a and the lower shank portion 36 is disposed adjacent to the tip 24 of the fastener 20a. The upper and lower shank portions 32, 36 are spaced from one another by the transition zone 34a of the shank 26, which is disposed between the upper shank portion 32 and the lower shank portion 36. Accordingly, the upper shank portion 32 extends longitudinally from the head 22 to the transition zone 34a, the transition zone 34a extends longitudinally from the upper shank portion 32 to the lower shank portion 36, and the lower shank portion 36 extends longitudinally from the transition zone 34a to the tip 24. As shown in FIGS. 6 and 7, the head 22, the tip 24, the upper shank portion 32, the transition zone 34a of the shank 26, and the lower shank portion 36 are all aligned with one another and are arranged co-axially and sequentially along a longitudinal axis 38 of the fastener 20a.

It should be appreciated that the head 22 and the tip 24 of the fastener 20a may be provided in a variety of different configurations without departing from the scope of the present disclosure. The head 22 of the fastener 20a illustrated in FIGS. 6 and 7 has an upper face 40 that is slightly domed adjacent a perimeter 42 of the head 22 and that is flat (i.e. transverse to the longitudinal axis 38) at the center of the head 22. The head 22 also includes a bottom face 44 that is flat (i.e. transverse to the longitudinal axis 38). Notwithstanding this exemplary arrangement, other configurations for the head 22 are possible. By way of non-limiting example, the upper face 40 of the head 22 may be completely flat and the bottom face 44 of the head 22 may have a frusto-conical shape and/or include a concave under-cut (not shown). The tip 24 of the fastener 20a illustrated in FIGS. 6 and 7 includes three convergent faces 46 that are angled relative to the longitudinal axis 38 to give the tip 24 a pointed shape. Notwithstanding this exemplary arrangement, other configurations for the tip 24 are possible. By way of non-limiting example, the tip 24 may include any number of multiple convergent faces or a single face that is angled relative to the longitudinal axis 38. In another non-limiting example, the tip 24 may have a conical shape.

As best seen in FIGS. 6-9, the upper shank portion 32 of the fastener 20a has a smooth cylindrical shape and the lower shank portion 36 of the fastener 20a has a plurality of lower retention rings 50. Each retention ring 50 in the plurality of lower retention rings 50 on the lower shank portion 36 increase in diameter moving toward the head 22 of the fastener 20a. In other words, each of the retention rings 50 in the plurality of lower retention rings 50 increase in diameter moving toward the transition zone 34a of the shank 26. Each of the retention rings 50 in the plurality of lower retention rings 50 extends radially around at least part of the shank 26, meaning that the retention rings 50 may or may not extend a full 360 degrees about the shank 26.

As best seen in FIGS. 8 and 9, each retention ring 50 in the plurality of lower retention rings 50 on the lower shank portion 36 includes a ramped face 58, an outer edge 60, and a barb face 62. The ramped face 58 has a frusto-conical shape and is angled relative to longitudinal axis 38 such that each retention ring 50 in the plurality of lower retention rings 50 increases in diameter moving towards the transition zone 34a (i.e. moving towards the head 22 of the fastener 20a). The barb face 62 extends annularly about the shank 26 and may be abruptly curved, undercut, or flat and transverse to the longitudinal axis 38 of the fastener 20a. The ramped face 58 and the barb face 62 of each retention ring 50 in the plurality of lower retention rings 50 extend (i.e. project) from the lower shank portion 36 and meet (i.e. converge) at the outer edge 60. The outer edge 60 may be sharp or rounded. The shank diameter 30 at the lower shank portion 36 of the fastener 20a is measured across the outer edge 60 of one of the retention rings 50 in the plurality of lower retention rings 50. The shank diameter 30 at the upper and lower shank portions 32, 36 of the fastener 20a may be the same or may be different. In the example illustrated in FIGS. 6-13, the shank diameter 30 is the same at both the upper and lower shank portions 32, 36 of the fastener 20a.

The transition zone 34a of the fastener 20a may have a variety of different arrangements. In FIGS. 6-13, the transition zone 34a includes multiple longitudinal grooves 64 that define multiple longitudinal ribs 66a. The multiple longitudinal grooves 64 run parallel to the longitudinal axis 38 of the fastener 20a and extend radially into the shank 26 in the transition zone 34a. The multiple longitudinal ribs 66a also run parallel to the longitudinal axis 38 of the fastener 20a and are disposed between the multiple longitudinal grooves 64. The multiple longitudinal grooves 64 and thus the multiple longitudinal ribs 66a are circumferentially spaced about the transition zone 34a of the shank 26 in a sequentially indexed arrangement. As best seen in FIG. 9, each of the multiple longitudinal grooves 64 has a groove width 68 and each of the multiple longitudinal ribs 66a has a rib width 70. As such, the multiple longitudinal grooves 64 are spaced from one another by the rib width 70 and the multiple longitudinal ribs 66a are spaced from one another by the groove width 68. Although other arrangements are possible, in the illustrated example, the groove width 68 is smaller than the rib width 70. Advantageously, the multiple longitudinal ribs 66a increase the lateral shear strength of the transition zone 34a of the shank 26.

The transition zone 34a of the fastener 20a has a transition zone diameter 72a. In accordance with the arrangement illustrated in FIGS. 6-13, the multiple longitudinal ribs 66a do not extend radially beyond the retention rings 50 in the plurality of lower retention rings 50. In other words, the multiple longitudinal ribs 66a are radially inset relative to the outer edges 60 of the retention rings 50 in the plurality of lower retention rings 50. Accordingly, the transition zone diameter 72a is less than or equal to the shank diameter 30 of the upper and lower shank portions 32, 36 of the shank 26. Optionally, the transition zone 34a may further include one or more annular grooves 74a, 74b. The annular grooves 74a, 74b circumscribe the shank 26 and extend radially into the shank 26 in the transition zone 34a. Annular groove 74a separates the multiple longitudinal ribs 66a of the transition zone 34a from the upper shank portion 32 and annular groove 74b separates the multiple longitudinal ribs 66a of the transition zone 34a from the plurality of lower retention rings 50 on the lower shank portion 36. The multiple longitudinal grooves 64 may or may not be opened to the annular grooves 74a, 74b.

With reference to FIGS. 10-13, the fastener 20a is shown in combination with a first building component 76. The first building component 76 may be made from a variety of different materials including solid wood, fiber boards, composites, laminates, plastics, metal, and other substrate materials. For example and without limitation, the first building component 76 may be a piece of plywood or lumber. The first building component 76 has an upper surface 78, a lower surface 80 that is spaced from the upper surface 78, and a thickness 82 that is measured between the upper and lower surfaces 78, 80. As shown in FIG. 13, the fastener 20a is designed to be driven into the first building component 76 to a position where the head 22 impacts the upper surface 78 of the first building component 76 and the tip 24 protrudes from the lower surface 80 of the first building component 76. The transition zone 34a on the shank 26 of the fastener 20a is spaced from the head 22 by a pre-determined distance 84 that is associated with the thickness 82 of the first building component 76. The pre-determined distance 84 is selected to align the transition zone 34a of the fastener 20a with the lower surface 80 of the first building component 76 when the head 22 of the fastener 20a is aligned with the upper surface 78 of the first building component 76. The transition zone 34a of the fastener 20a also has a pre-determined length 86a. In the illustrated example, the pre-determined length 86a of the transition zone 34a may equal one to two times the shank diameter 30, but other configurations are possible. The pre-determined length 86a is also selected to align the transition zone 34a of the fastener 20a with the lower surface 80 of the first building component 76 when the head 22 of the fastener 20a is aligned with the upper surface 78 of the first building component 76. As such, the fastener 20a may be provided in various configurations that are specially adapted for use with first building components 76 of different thicknesses 82.

The location of the transition zone 34a along the shank 26 (i.e. the length of pre-determined distance 84 and the pre-determined length 86a) may be used to visually confirm whether the fastener 20a being used is appropriate for any given thickness 82 of the first building component 76. This task may be accomplished by performing the following method steps. First, the fastener 20a is placed adjacent and transverse to the first building component 76. Second, the bottom face 44 of the head 22 of the fastener 20a is aligned with the upper surface 78 of the first building component 76. Third, visual inspection is used to determine whether the fastener 20a is appropriate for the thickness 82 of the first building component 76. If the transition zone 34a of the fastener 20a is aligned with the lower surface 80 of the first building component 76 (i.e. if the lower surface 80 intersects with the transition zone 34a, as illustrated in FIG. 10), then the fastener 20a is appropriate for the thickness 82 of the first building component 76. If the transition zone 34a of the fastener 20a is entirely below the lower surface 80 of the first building component 76 (i.e. if all of the transition zone 34a extends past the lower surface 80, as illustrated in FIG. 11), then the fastener 20a is not appropriate for the thickness 82 of the first building component 76. Finally, if the transition zone 34a of the fastener 20a is entirely above the lower surface 80 of the first building component 76 (i.e. if all of the transition zone 34a is disposed between the upper and lower surfaces 78, 80, as illustrated in FIG. 12), then the fastener 20a is not appropriate for the thickness 82 of the first building component 76.

FIG. 13 illustrates the fastener 20a after the fastener 20a has been driven into the first and second building components 76, 88. It should be appreciated that the fastener 20a may be driven into the first and second building components 76, 88 in a number of different ways. For example and without limitation, where the fastener 20a has a nail-like configuration, the fastener 20a may be driven into the first and second building components 76, 88 manually using a hammer or with a nail gun. As shown in FIG. 13, the first and second building components 76, 88 are joined together by the fastener 20a at a joint 90 where the lower surface 80 of the first building component 76 abuts the second building component 88. It should be appreciated that when the fastener 20a is appropriately selected for the thickness 82 of the first building component 76 (as shown in FIG. 13), the joint 90 is aligned with (i.e. intersects) the transition zone 34a of the fastener 20a. In other words, the transition zone 34a of the fastener 20a is arranged so as to straddle the joint 90 between the first and second building components 76, 88. As a result of this alignment, all of the retention rings 50 in the plurality of lower retention rings 50 on the lower shank portion 36 of the fastener 20a resist separation of the first and second building components 76, 88. This improves the holding force and pull-though performance of the fastener 20a.

Another fastener 20b constructed in accordance with the present disclosure is illustrated in FIGS. 14-18. The fastener 20b illustrated in FIGS. 14-18 is identical to the fastener 20a illustrated in FIGS. 6-13 except that the fastener 20b shown in FIGS. 14-18 has a transition zone 34b with modified longitudinal ribs 66b. The multiple longitudinal ribs 66b run parallel to the longitudinal axis 38 of the fastener 20a and are disposed between the multiple longitudinal grooves 64. The multiple longitudinal grooves 64 and thus the multiple longitudinal ribs 66b are circumferentially spaced about the transition zone 34b of the shank 26 in a sequentially indexed arrangement where the multiple longitudinal grooves 64 are spaced from one another by the rib width 70 and the multiple longitudinal ribs 66b are spaced from one another by the groove width 68. Where fastener 20b differs from fastener 20a is that the multiple longitudinal ribs 66b extend radially beyond the retention rings 50 in the plurality of lower retention rings 50. In other words, the multiple longitudinal ribs 66b project radially beyond the outer edges 60 of the retention rings 50 in the plurality of lower retention rings 50. Accordingly, the fastener 20b shown in FIGS. 14-18 has a transition zone diameter 72b measured across the multiple longitudinal ribs 66b that is larger than the shank diameter 30 of the upper and lower shank portions 32, 36 of the shank 26. Advantageously, this arrangement of the multiple longitudinal ribs 66b increases the lateral shear strength of the transition zone 34b of the shank 26. In addition, because the multiple longitudinal ribs 66b project radially beyond the outer edges 60 of the retention rings 50 in the plurality of lower retention rings 50, the multiple longitudinal ribs 66b dig into the first and/or second building components 76, 88 and resist rotation of the fastener 20b relative to the first and/or second building components 76, 88.

Another fastener 20c constructed in accordance with the present disclosure is illustrated in FIGS. 19-23. The fastener 20c illustrated in FIGS. 19-23 is identical to the fastener 20a illustrated in FIGS. 6-13 except that the fastener 20c shown in FIGS. 19-23 has a transition zone 34c that is elongated. The transition zone 34c of the fastener 20c shown in FIGS. 19-23 has a pre-determined length 86c that is longer than the pre-determined length 86a of the transition zone 34a of the fastener 20a shown in FIGS. 6-13. Unlike the transition zone 34a of fastener 20a, the fastener 20c shown in FIGS. 19-23 does not have annular grooves 74a, 74b separating the multiple longitudinal ribs 66c from the upper shank portion 32 and the second plurality of retention rings 50 on the lower shank portion 36. Instead, the transition zone 34c has one or more annular grooves 74c, 74d that are spaced from one another and from the upper and lower shank portions 32, 36. As such, the transition zone 34c has multiple longitudinal ribs 66c that are segmented where the annular grooves 74c, 74d cross the multiple longitudinal ribs 66c. The multiple longitudinal grooves 64 extending between the multiple longitudinal ribs 66c may or may not be opened to the annular grooves 74c, 74d.

With reference to FIGS. 21-23, the fastener 20c is shown in combination with the first building component 76. Again, the first building component 76 may be made from a variety of different materials including wood, plastics, metal, and other substrate materials. For example and without limitation, the first building component 76 may be a piece of plywood, lumber, or a wood-like building material. The transition zone 34c on the shank 26 of the fastener 20c is spaced from the head 22 by the pre-determined distance 84 associated with the thickness 82 of the first building component 76. The pre-determined distance 84 is selected to align the transition zone 34c of the fastener 20c with the lower surface 80 of the first building component 76 when the head 22 of the fastener 20c is aligned with the upper surface 78 of the first building component 76. The transition zone 34c of the fastener 20c also has a pre-determined length 86c. The pre-determined length 86c of the transition zone 34c of the fastener 20c shown in FIGS. 19-23 is longer than the pre-determined length 86a of the transition zone 34a of the fastener 20a shown in FIGS. 6-13. The pre-determined length 86c of transition zone 34c is selected to encompass a wider range of thicknesses 82 of the first building component 76. As shown in FIGS. 21-23, the lower surface 80 of the first building component 76 remains aligned with the transition zone 34c even when the fastener 20c is used with first building components 76 of different thicknesses 82. As such, FIGS. 21-23 all illustrate appropriate uses of fastener 20c. The annular grooves 74c, 74d of the transition zone 34c may be associated with first building components 76 of different thicknesses 82 and can be useful in demarcating the transition zone 34c.

Another fastener 20d constructed in accordance with the present disclosure is illustrated in FIGS. 24 and 25. The fastener 20d illustrated in FIGS. 24 and 25 is identical to the fastener 20a illustrated in FIGS. 6-13 except that the fastener 20d shown in FIGS. 24 and 25 has a transition zone 34d that is elongated and has a bulbous (i.e. outwardly bulging) shape. The transition zone 34d of the fastener 20d shown in FIGS. 24 and 25 has a pre-determined length 86d that is longer than the pre-determined length 86a of the transition zone 34a of the fastener 20a shown in FIGS. 6-13. Unlike the transition zone 34a of fastener 20a, the transition zone 34d of the fastener 20d shown in FIGS. 24 and 25 does not have multiple longitudinal grooves 64 or multiple longitudinal ribs 66a. Instead, the transition zone 34d has multiple annular grooves 74e-74h that are spaced from one another and that separate the transition zone 34d into multiple segments 92a-92c. Segment 92a is disposed adjacent the upper shank portion 32, segment 92c is disposed adjacent the lower shank portion 36, and segment 92b is disposed between segments 92a and 92c of the transition zone 34d. The multiple annular grooves 74e-74h circumscribe the shank 26 and extend radially into the shank 26 in the transition zone 34d. Annular groove 74e separates segment 92a of the transition zone 34d from the upper shank portion 32 and annular groove 74h separates segment 92c of the transition zone 34d from the plurality of lower retention rings 50 on the lower shank portion 36. Annular groove 74f separates segment 92a and segment 92b of the transition zone 34d from one another and annular groove 74g separates segment 92b and segment 92c of the transition zone 34d from one another. Segments 92a-92c give the transition zone 34d a convex outer surface 94. The convex outer surface 94 of the transition zone 34d extends radially beyond the retention rings 50 in the plurality of lower retention rings 50. In other words, the convex outer surface 94 of the transition zone 34d projects radially beyond the outer edges 60 of the retention rings 50 in the plurality of lower retention rings 50. Accordingly, the fastener 20d shown in FIGS. 24 and 25 has a transition zone diameter 72d measured across segment 92b of the transition zone 34d that is larger than the shank diameter 30 of the upper and lower shank portions 32, 36 of the shank 26. Advantageously, this arrangement increases the lateral shear strength of the transition zone 34d of the shank 26.

Another fastener 20e constructed in accordance with the present disclosure is illustrated in FIGS. 26 and 27. The fastener 20e extends longitudinally between a head 122 and a tip 124. The fastener 20e also includes a shank 126 disposed between the head 122 and the tip 124. The head 122 of the fastener 20e has a head diameter 128 and the shank 126 of the fastener 20e has a shank diameter 130 that is smaller than the head diameter 128. The tip 124 of the fastener 20e tapers from the shank diameter 130 to a point (i.e. the tip 124 of the fastener 20e is pointed). The shank 126 of the fastener 20e includes an upper shank portion 132e and a lower shank portion 136 that are generally cylindrical in shape. The upper shank portion 132e is disposed adjacent to the head 122 of the fastener 20e and the lower shank portion 136 is disposed adjacent to the tip 124 of the fastener 20e. The upper and lower shank portions 132e, 136 are spaced from one another by an anti-rotation portion 133e of the shank 126 that has a non-circular cross-section. The anti-rotation portion 133e of the shank 126 is disposed between the upper shank portion 132e and the lower shank portion 136. Accordingly, the upper shank portion 132e extends longitudinally from the head 122 to the anti-rotation portion 133e of the shank 26, the anti-rotation portion 133e of the shank 126 extends longitudinally from the upper shank portion 132e to the lower shank portion 136, and the lower shank portion 136 extends longitudinally from the anti-rotation portion 133e of the shank 126 to the tip 124. As shown in FIGS. 26 and 27, the head 122, the tip 124, the upper shank portion 132e, the anti-rotation portion 133e of the shank 126, and the lower shank portion 136 are all aligned with one another and are arranged co-axially and sequentially along a longitudinal axis 138 of the fastener 20e.

It should be appreciated that the head 122 and the tip 124 of the fastener 20e may be provided in a variety of different configurations without departing from the scope of the present disclosure. The head 122 of the fastener 20a illustrated in FIGS. 26 and 27 has an upper face 140 that is slightly domed adjacent a perimeter 142 of the head 122 and that is flat (i.e. transverse to the longitudinal axis 138) at the center of the head 122. The head 122 may be provided with a tool interface 143. The tool interface 143 is configured to mate with a tool, including without limitation, a Phillips head screw driver, a flat head screw driver, a hex head driver, or a torx head driver. The head 122 also includes a bottom face 144 that has a frusto-conical base 145 and a concave under-cut 147 that extends longitudinally into the head 122 and annularly between the frusto-conical base 145 and the perimeter 142 of the head 122. Notwithstanding this exemplary arrangement, other configurations for the head 122 are possible. The tip 124 of the fastener 20e illustrated in FIGS. 26 and 27 includes three convergent faces 146 that are angled relative to the longitudinal axis 138 to give the tip 124 a pointed shape. Notwithstanding this exemplary arrangement, other configurations for the tip 124 are possible. By way of non-limiting example, the tip 124 may include any number of multiple convergent faces or a single face that is angled relative to the longitudinal axis 138. In another non-limiting example, the tip 124 may have a conical shape.

The upper shank portion 132e of the fastener 20e illustrated in FIGS. 26 and 27 is smooth. The upper shank portion 132e is connected to the anti-rotation portion 133e of the shank 126 at a frangible break-away connection 149e. By contrast, the lower shank portion 136 of the fastener 20e is not smooth and includes plurality of lower retention rings 150. Each of the retention rings 150 in the plurality of lower retention rings 150 extends radially around at least part of the shank 126, meaning that the retention rings 150 may or may not extend a full 360 degrees about the shank 126.

The anti-rotation portion 133e of the shank 126 includes first and second faces 151a, 151b that are flat and that oppose one another. The first and second faces 151a, 151b are inwardly angled towards the longitudinal axis 138 of the fastener 20e moving from the lower shank portion 136 to the upper shank portion 132e. In addition, the first and second faces 151a, 151b have a width 153e that increases moving from the lower shank portion 136 to the upper shank portion 132e. The shank diameter 130 at the upper and lower shank portions 132e, 136 of the fastener 20e may be the same or may be different. In the example illustrated in FIGS. 26 and 27, the shank diameter 130 is the same at both the upper and lower shank portions 132e, 136 of the fastener 20e. The width 153e of the first and second faces 151a, 151b of the anti-rotation portion 133e of the shank 126 reaches a maximum at or near the frangible break-away connection 149e, where the width 153e of the first and second faces 151a, 151b is larger than the shank diameter 130 of the upper and lower shank portions 132e, 136.

When the fastener 20e is driven into the first and second building components 76, 88, the first and second faces 151a, 151b of the anti-rotation portion 133e of the shank 126 dig into the first and second building components 76, 88 and resist rotation. By applying a twisting force to the head 122 via the tool interface 143, the upper shank portion 132 and the head 122 of the fastener 20e can be separated from the anti-rotation portion 133e and the lower shank portion 136 at the frangible break-away connection 149e. This feature of the fastener 20e shown in FIGS. 26 and 27 can be beneficial in certain applications where planned separation of the first and second building components 76, 88 is desired. One exemplary and non-limiting application where this feature is particularly advantageous is in pallet construction. The frangible break-away connection 149e is spaced a pre-set distance 155 away from the bottom face 144 of the head 122. Accordingly, the pre-set distance 155 between the frangible break-away connection 149e and the bottom face 144 of the head 122 can be selected relative to the thickness 82 of the first building component 76 so that the shank 126 of the fastener 20e does not protrude from the first and/or second building components 76, 88 after separation. This provides material handling and safety benefits because the shank 126 of the fastener 20e does not protrude from the first and/or second building components 76, 88.

Each retention ring 150 in the plurality of lower retention rings 150 on the lower shank portion 136 includes a ramped face 158, an outer edge 160, and a barb face 162. The ramped face 158 has a frusto-conical shape and is angled relative to longitudinal axis 138 such that each retention ring 150 in the plurality of lower retention rings 150 increases in diameter moving towards the anti-rotation portion 133e of the shank 126 (i.e. moving towards the head 122 of the fastener 20e). The barb face 162 extends annularly about the shank 126 and may be abruptly curved, undercut, or flat and transverse to the longitudinal axis 138 of the fastener 20e. The ramped face 158 and the barb face 162 of each retention ring 150 in the plurality of lower retention rings 150 extend (i.e. project) from the lower shank portion 136 and meet (i.e. converge) at the outer edge 160. The outer edge 160 may be sharp or rounded. The shank diameter 130 at the lower shank portion 136 of the fastener 20e is measured across the outer edge 160 of one of the retention rings 150 in the plurality of lower retention rings 150. The plurality of lower retention rings 150 on the lower shank portion 136 act in concert with the head 122 to oppose separation of the first and second building components 76, 88 prior to planned frangible separation of the fastener 20e.

Another fastener 20f constructed in accordance with the present disclosure is illustrated in FIG. 28. The fastener 20f illustrated in FIG. 28 is identical to the fastener 20e illustrated in FIGS. 26 and 27 except that the shank 126 of fastener 20f shown in FIG. 28 has an anti-rotation portion 133f that has four faces 151c-f that are flat and are outwardly angled away from the longitudinal axis 138 of the fastener 20f moving from the lower shank portion 136 to the upper shank portion 132e. As such, the four faces 151c-f of the anti-rotation portion 133f of the fastener 20f shown in FIG. 28 have a width 153f that increases moving from the lower shank portion 136 to the upper shank portion 132. The width 153f of the four faces 151c-f of the anti-rotation portion 133f of the shank 126 reaches a maximum at or near the frangible break-away connection 149e, where the width 153f of the four faces 151c-f of the anti-rotation portion 133f is larger than the shank diameter 130 of the upper and lower shank portions 132e, 136. When the fastener 20f is driven into the first and second building components 76, 88, the four faces 151c-f of the anti-rotation portion 133f of the shank 126 dig into the first and second building components 76, 88 and resist rotation.

Another fastener 20g constructed in accordance with the present disclosure is illustrated in FIGS. 29-32. The fastener 20g illustrated in FIGS. 29-32 is identical to the fastener 20e illustrated in FIGS. 26 and 27 except that the shank 126 of fastener 20g shown in FIGS. 29-32 has an anti-rotation portion 133g that has two ears 161a, 161b that protrude outwardly from the anti-rotation portion 133g of the shank 126, an upper shank portion 132g with a plurality of upper retention rings 148, and a frangible break-away connection 149g connection that further includes one or more flute-like spirals 163. As best seen in FIG. 31, the two ears 161a, 161b of anti-rotation portion 133g are arranged opposite one another in a common plane 165 that bisects the shank 126. The longitudinal axis 138 of the fastener 20g is also located in common plane 165. The two ears 161a, 161b of anti-rotation portion 133g illustrated in FIGS. 29-32 are flush with the first and second faces 151a, 151b, but could alternatively be inset relative to the first and second faces 151a, 151b (as shown in FIGS. 33-36). The two ears 161a, 161b of anti-rotation portion 133g give the anti-rotation portion 133g of the fastener 20g a width 153g that reaches a maximum at or near the frangible break-away connection 149g, where the width 153g of the two ears 161a, 161b of the anti-rotation portion 133g is larger than the shank diameter 130 of the upper and lower shank portions 132g, 136. When the fastener 20g is driven into the first and second building components 76, 88, the two ears 161a, 161b of the anti-rotation portion 133g of the shank 126 dig into the first and second building components 76, 88 and resist rotation.

The flute-like spirals 163 of the frangible break-away connection 149g facilitate the separation of the head 122 and the upper shank portion 132g from the anti-rotation portion 133g and the lower shank portion 136. Each retention ring 148 in the plurality of upper retention rings 148 on the upper shank portion 132g increase in diameter moving toward the head 122 of the fastener 20g. In other words, each retention ring 148 in the plurality of upper retention rings 148 increase in diameter moving away from the anti-rotation portion 133g of the shank 126. Each of the retention rings 148 in the plurality of upper retention rings 148 extends radially around at least part of the shank 126, meaning that the retention rings 148 may or may not extend a full 360 degrees about the shank 126.

Each retention ring 148 in the plurality of upper retention rings 148 on the upper shank portion 132g includes a ramped face 152, an outer edge 154, and a barb face 156. The ramped face 152 has a frusto-conical shape and is angled relative to longitudinal axis 138 such that each retention ring 148 in the plurality of upper retention rings 148 increases in diameter moving away from the anti-rotation portion 133g (i.e. moving towards the head 122 of the fastener 20g). The barb face 156 extends annularly about the shank 126 and may be abruptly curved, undercut, or flat and transverse to the longitudinal axis 138 of the fastener 20g. The ramped face 152 and the barb face 156 of each retention ring 148 in the plurality of upper retention rings 148 extend (i.e. project) from the upper shank portion 132g and meet (i.e. converge) at the outer edge 154. The outer edge 154 may be sharp or rounded. The shank diameter 130 at the upper shank portion 132g of the fastener 20g is measured across the outer edge 154 of one of the retention rings 148 in the plurality of upper retention rings 148. Together, the retention rings 148 in the plurality of upper retention rings 148 on the upper shank portion 132g of the fastener 20g and the retention rings 150 in the plurality of lower retention rings 150 on the lower shank portion 136 of the fastener 20g resist separation of the first and second building components 76, 88. This improves the holding force and pull-through performance of the fastener 20g.

Another fastener 20h constructed in accordance with the present disclosure is illustrated in FIGS. 33-36. The fastener 20h illustrated in FIGS. 33-36 is identical to the fastener 20g illustrated in FIGS. 29-32 except that the shank 126 of fastener 20h shown in FIGS. 33-36 has an anti-rotation portion 133h with two ears 161c, 161d that are inset with respect to the first and second faces 151a, 151b and an upper shank portion 132h that has at least one helical thread 167. The helical thread 167 of the upper shank portion 132h of the fastener 20h shown in FIGS. 33-36 causes the head 122 and the upper shank portion 132h to back out of the first building component 76 by continued rotation of the head 122 via the tool interface 143 after the frangible break-away connection 149g separates (i.e. breaks). The two ears 161c, 161d of anti-rotation portion 133h give the anti-rotation portion 133h of the fastener 20h a width 153h that reaches a maximum at or near the frangible break-away connection 149g, where the width 153h of the two ears 161c, 161d of the anti-rotation portion 133h is larger than the shank diameter 130 of the upper and lower shank portions 132h, 136. When the fastener 20h is driven into the first and second building components 76, 88, the two ears 161c, 161d of the anti-rotation portion 133h of the shank 126 dig into the first and second building components 76, 88 and resist rotation.

Another fastener 20i constructed in accordance with the present disclosure is illustrated in FIGS. 37-39. The fastener 20i illustrated in FIGS. 37-39 is identical to the fastener 20g illustrated in FIGS. 29-32 except that the shank 126 of fastener 20i shown in FIGS. 37-39 has an anti-rotation portion 1331 with two ears 161c, 161d that are inset with respect to the first and second faces 151a, 151b (like those found on fastener 20h shown in FIGS. 33-36) and a transition zone 134 (like that found on fastener 20a shown in FIGS. 6-13) that is disposed longitudinally between an upper shank portion 1321 and the frangible break-away connection 149g. In addition, the upper shank portion 1321 of fastener 20i has a smooth, cylindrical shape and lacks the plurality of upper retention rings 148 that are on the upper shank portion 132g of fastener 20g.

The transition zone 134 of the fastener 20i includes multiple longitudinal grooves 164 that define multiple longitudinal ribs 166. The multiple longitudinal grooves 164 run parallel to the longitudinal axis 138 of the fastener 20i and extend radially into the shank 126 in the transition zone 134. The multiple longitudinal ribs 166 also run parallel to the longitudinal axis 138 of the fastener 20i and are disposed between the multiple longitudinal grooves 164. The multiple longitudinal grooves 164 and thus the multiple longitudinal ribs 166 are circumferentially spaced about the transition zone 134 of the shank 126 in a sequentially indexed arrangement. Advantageously, the multiple longitudinal ribs 166 increase the lateral shear strength of the transition zone 134 of the shank 26.

The transition zone 134 of the fastener 20i has a transition zone diameter 172. In accordance with the arrangement illustrated in FIGS. 37-39, the multiple longitudinal ribs 166 do not extend radially beyond the retention rings 150 in the plurality of lower retention rings 150. In other words, the multiple longitudinal ribs 166 are radially inset relative to the outer edges 160 of the retention rings 150 in the plurality of lower retention rings 150. Accordingly, the transition zone diameter 172 is less than or equal to the shank diameter 130 of the upper and lower shank portions 132g, 136 of the shank 126.

The transition zone 134 on the shank 126 of the fastener 201 is spaced from the head 122 by a pre-determined distance 184 that is associated with the thickness 82 of the first building component 76. The pre-determined distance 184 is selected to align the transition zone 134 of the fastener 201 with the lower surface 80 of the first building component 76 when the head 122 of the fastener 201 is aligned with the upper surface 78 of the first building component 76. The transition zone 134 of the fastener 201 also has a pre-determined length 186. In the illustrated example, the pre-determined length 186 of the transition zone 134 may equal one to two times the shank diameter 130, but other configurations are possible. The pre-determined length 186 is also selected to align the transition zone 134 of the fastener 201 with the lower surface 80 of the first building component 76 when the head 22 of the fastener 201 is aligned with the upper surface 78 of the first building component 76. As such, the fastener 201 may be provided in various configurations that are specially adapted for use with first building components 76 of different thicknesses 82. Because the frangible break-away connection 149g is below the transition zone 134, the shank 126 will break off inside the second building component 88. The location of the transition zone 134 along the shank 126 (i.e. the length of pre-determined distance 184 and the pre-determined length 186) may be used to visually confirm whether the fastener 201 being used is appropriate for any given thickness 82 of the first building component 76. This task may be accomplished by performing the same method steps described above.

Another fastener 20j constructed in accordance with the present disclosure is illustrated in FIGS. 40-42. The fastener 20j extends longitudinally between a head 222 and a tip 224. The fastener 20j also includes a shank 226 disposed between the head 222 and the tip 224. The head 222 of the fastener 20j has a head diameter 228 and the shank 226 of the fastener 20j has a shank diameter 230 that is smaller than the head diameter 228. The shank 226 of the fastener 20j includes an upper shank portion 232 and a lower shank portion 236j that are generally cylindrical in shape. The upper shank portion 232 is disposed adjacent to the head 222 of the fastener 20j and the lower shank portion 236j is disposed adjacent to the tip 224 of the fastener 20j. Accordingly, the upper shank portion 232 extends longitudinally from the head 222 to the lower shank portion 236j and the lower shank portion 236j extends longitudinally from the upper shank portion 232 to the tip 224. As shown in FIG. 40, the head 222, the tip 224, the upper shank portion 232 and the lower shank portion 236j are all aligned with one another and are arranged co-axially and sequentially along a longitudinal axis 238 of the fastener 20j.

It should be appreciated that the head 222 and the tip 224 of the fastener 20j may be provided in a variety of different configurations without departing from the scope of the present disclosure. The head 222 of the fastener 20j illustrated in FIGS. 40-42 includes an upper face 240 and a bottom face 244 that are flat. Notwithstanding this exemplary arrangement, other configurations for the head 222 are possible. The tip 224 of the fastener 20j illustrated in FIGS. 40-42 preferably includes a single face 246 that is angled relative to the longitudinal axis 138. As will be explained below, the lower shank portion 236j of the fastener 20j illustrated in FIGS. 40-42 is designed to bend, thereby clinching the first and second building components 76, 88 together. The single face 246 of the tip 224 in the illustrated example facilitates the bending of the lower shank portion 236j of the fastener 20j by placing a lateral force on the tip 224.

The upper shank portion 232 of the fastener 20j illustrated in FIGS. 40-42 is smooth. The lower shank portion 236j of the fastener 20j is also smooth except for one or more relief cuts 247 disposed longitudinally along one side of the lower shank portion 236j. The shank 226 of the fastener 20j has a centerline plane 249 that bisects the shank 226. The longitudinal axis 238 of the fastener 20j is located in the centerline plane 249. The relief cuts 247 are radially aligned with one another and are all positioned to one side of the centerline plane 249 of the fastener 20j. The relief cuts 247 may have a semi-cylindrical shape and facilitate the bending of the lower shank portion 236j of the fastener 20j. FIG. 42 shows the fastener 20j after it has been driven into the first and second building components 76, 88 to a position where the bottom face 244 of the head 222 has impacted the upper surface 78 of the first building component 76. The upper shank portion 232 extends entirely through the first building component 76 such that the lower shank portion 236j is embedded entirely within the second building component 88. The combination of the single face 246 of the tip 224 and the relief cuts 247 causes the lower shank portion 236j to bend and clinch the first and second building components 76, 88 together. As result, the fastener 20j holds the first and second building components 76, 88 together securely and resists separation of the first and second building components 76, 88. Accordingly, the fastener 20j illustrated in FIGS. 40-42 may be characterized as a clinch nail. The radius of the bend in the lower shank portion 236j can be controlled using the angle of the single face 246 of the tip 224 relative to the longitudinal axis 238 of the fastener 20j and the geometry, location, and number of the relief cuts 247 in the lower shank portion 236j.

Another fastener 20k constructed in accordance with the present disclosure is illustrated in FIG. 43. The fastener 20k illustrated in FIG. 43 is identical to the fastener 20j illustrated in FIGS. 40-42 except that the shank 226 of fastener 20k shown in FIG. 43 has a lower shank portion 236k that includes a plurality of lower retention rings 250 and a plurality of tapered faces 251 disposed between the relief cuts 247. Each of the retention rings 250 in the plurality of lower retention rings 250 extends radially around at least part of the shank 226, meaning that the retention rings 250 may or may not extend a full 360 degrees about the shank 226. Each retention ring 250 in the plurality of lower retention rings 250 on the lower shank portion 236 includes a ramped face 258, an outer edge 260, and a barb face 262. The ramped face 258 has a frusto-conical shape and is angled relative to longitudinal axis 238 such that each retention ring 250 in the plurality of lower retention rings 250 increases in diameter moving towards the head 222 of the fastener 20k. The barb face 262 extends annularly about the shank 226 and may be abruptly curved, undercut, or flat and transverse to the longitudinal axis 238 of the fastener 20k. The ramped face 258 and the barb face 262 of each retention ring 250 in the plurality of lower retention rings 250 extend (i.e. project) from the lower shank portion 236 and meet (i.e. converge) at the outer edge 260. The outer edge 260 may be sharp or rounded. The shank diameter 230 at the lower shank portion 236 of the fastener 20k is measured across the outer edge 260 of one of the retention rings 250 in the plurality of lower retention rings 250. The plurality of lower retention rings 250 on the lower shank portion 236 act in concert with the head 222 to oppose separation of the first and second building components 76, 88.

Like the plurality of lower retention rings 250, the plurality of tapered faces 251 disposed between the relief cuts 247 are angled towards the tip 224 of the fastener 20k. The plurality of tapered faces 251 are radially aligned with the relief cuts 247 and therefore are positioned along one side of the centerline plane 249. Due to their angle, the plurality of tapered faces 251 further facilitate the bending of the lower shank portion 236 of the fastener 20k because a lateral force will act on each of the plurality of tapered faces 251 as the fastener 20k is being driven into the first and second building components 76, 88.

Another fastener 201 constructed in accordance with the present disclosure is illustrated in FIG. 44. The fastener 201 extends longitudinally between a head 322 and a tip 324. The fastener 201 also includes a shank 326 disposed between the head 322 and the tip 324. The head 322 of the fastener 201 has a head diameter 328 and the shank 326 of the fastener 201 has a shank diameter 330 that is smaller than the head diameter 328. The shank 326 of the fastener 201 includes an upper shank portion 332 and a lower shank portion 336 that are generally cylindrical in shape. The upper shank portion 332 is disposed adjacent to the head 322 of the fastener 201 and the lower shank portion 336 is disposed adjacent to the tip 324 of the fastener 201. Accordingly, the upper shank portion 332 extends longitudinally from the head 322 to the lower shank portion 336 and the lower shank portion 336 extends longitudinally from the upper shank portion 332 to the tip 324.

It should be appreciated that the head 322 and the tip 324 of the fastener 201 may be provided in a variety of different configurations without departing from the scope of the present disclosure. The head 322 of the fastener 201 illustrated in FIG. 44 includes an upper face 340 and a bottom face 344 that are flat. Notwithstanding this exemplary arrangement, other configurations for the head 322 are possible. The tip 324 of the fastener 20j illustrated in FIGS. 40-42 preferably includes a single face 346 that is turned at an angle relative to the longitudinal axis 338. The lower shank portion 336 of the fastener 201 includes a helical bend 347 that is designed to rotate the fastener 201 as the fastener 201 is driven into the first and second building components 76, 88. This rotation of the fastener 201 clinches the first and second building components 76, 88 together. Both the upper shank portion 332 and the lower shank portion 336 of the fastener 201 are smooth.

FIG. 45 illustrates a variation of the fastener 201 illustrated in FIG. 44. In FIG. 45, a fastener 20m is illustrated that includes a pair of shanks 426a, 426b that are transverse to a bridge portion 428. The pair of shanks 426a, 426b are parallel to one another and extend along a pair of longitudinal axes 438a, 438b. Each one of the pair of shanks 426a, 426b extends from the bridge portion 428 to tip 424a and 424b, respectively. Each tip 424a, 424b has a single face 446a, 446b that is turned at an angle relative to each longitudinal axis 438a, 438b, respectively. Optionally, shank 426a may be longer than shank 426b. Each one of the pair of shanks 426a, 426b includes a helical bend 447a, 447b (like that of fastener 201 shown in FIG. 44) that is disposed near the tip 424a and 424b of each shank 426a, 426b. The helical bends 447a, 447b designed to rotate as the fastener 20k is driven into the first and second building components 76, 88. The rotation of the shanks 426a, 426b caused by the helical bends 447a, 447b clinches the first and second building components 76, 88 together. Accordingly, the fastener 20m shown in FIG. 45 may be characterized as a clinch staple. Each shank 426a, 426b may optionally be provided with one or more relief cuts 449 that allow the shanks 426a, 426b to rotate without deforming the bridge portion 428.

FIGS. 46-48 illustrate a different tip 524 and lower shank portion 536 that may be applied to any of the fasteners 20a-20i previously discussed. As shown in FIG. 46, the lower shank portion 536 includes plurality of lower retention rings 550. Each of the retention rings 550 in the plurality of lower retention rings 550 extends radially around at least part of the shank 526, meaning that the retention rings 550 may or may not extend a full 360 degrees about the shank 526. Each retention ring 550 in the plurality of lower retention rings 550 on the lower shank portion 536 includes a ramped face 558, an outer edge 560, and a barb face 562a or 562b. The ramped face 558 is gets progressively larger in diameter moving away from the tip 524. The retention rings 550 in the plurality of lower retention rings 550 are grouped together in three groups 563a-c that are separated by longitudinal gaps 565a, 565b. The barb face 562a of each retention ring 550 in the plurality of lower retention rings 550 is undercut except for the retention ring 550 of each group 563a-c that is closest to the tip 524, which has a barb face 562b that is flat and transverse to the longitudinal axis 538. As shown in FIGS. 46-48, the tip 524 includes four beveled blades 567a-d that are radially spaced about the tip 524. The four beveled blades 567a-d extend longitudinally from the tip 524 and each has a different longitudinal length 569 than the other beveled blades.

FIGS. 49 and 50 illustrate yet another tip 624 and lower shank portion 636 that may be applied to any of the fasteners 20a-20i previously discussed. The lower shank portion 636 may include at least one ridge 625 that projects radially outwardly from the lower shank portion 636 and that extends longitudinally along at least part of the lower shank portion 636 to the tip 624. As best seen in FIG. 50, the tip 624 has four blades 627a-d that are arranged to give the tip 624 a cross-like cross-section. The four blades 627a-d transition smoothly from one to the next, providing four curved channels 629a-d disposed between the four blades 627a-d. Each of the four blades 627a-d includes a leading edge 631a-d that tapers inwardly towards the longitudinal axis 638, giving the tip 624 a pointed shape. The leading edge 631a-d of each of the four blades 627a-d includes one or more projections 633a, 633b that bite into the first and/or second building components 76, 88. According to this construction, the tip 624 resists rotation relative to the first and second building components 76, 88.

Obviously, many modifications and variations of the present invention are possible in light of the above teachings and may be practiced otherwise than as specifically described while within the scope of the appended claims. Although not shown, it should be appreciated that any one of the transition portions 34a-d disclosed herein may be applied to any one of the fasteners 20e-20h and 20j-20m shown in FIGS. 26-36 and 40-50. Furthermore, any one of numerous surface features such as, but not limited to, various types of ring shanks, splines, grooves, knurl patterns, smooth surfaces, tapered surfaces, etching patterns, stamped patterns and shapes, and/or combinations thereof can be applied above and/or below transition portions 34a-d, 134 on any one of the fasteners 20a-20i disclosed herein so that application specific parameters can be accomplished. These antecedent recitations should be interpreted to cover any combination in which the inventive novelty exercises its utility. The use of the word “the” in the apparatus claims refers to an antecedent that is a positive recitation meant to be included in the coverage of the claims whereas the word “the” precedes a word not meant to be included in the coverage of the claims.

What is claimed is:

1. A fastener for securing a first building component to a second building component, said fastener comprising:
a head having a head diameter;
a shank connected to said head, said shank having a shank diameter that is less than said head diameter;
said shank extending along a longitudinal axis to a tip;
said shank including an upper shank portion adjacent said head, a lower shank portion adjacent said tip, and a transition zone positioned longitudinally between said upper shank portion and said lower shank portion; and
said transition zone being longitudinally spaced from said head by a pre-determined distance that is associated with a thickness of the first building component such that said transition zone is aligned with a joint between the first and second building components,
wherein said transition zone includes multiple longitudinal ribs that are circumferentially spaced about said transition zone,
wherein said multiple longitudinal ribs are radially inset relative to said upper shank portion and said lower shank portion giving said transition zone a transition zone diameter that is less than said shank diameter.

2. The fastener as set forth in claim 1, wherein said transition zone includes at least one annular groove.

3. A fastener for securing a first building component to a second building component, said fastener comprising:
a head having a head diameter;
a shank connected to said head, said shank having a shank diameter that is less than said head diameter;
said shank extending along a longitudinal axis to a tip;
said shank including an upper shank portion adjacent said head, a lower shank portion adjacent said tip, and a transition zone positioned longitudinally between said upper shank portion and said lower shank portion; and
said transition zone being longitudinally spaced from said head by a pre-determined distance that is associated with a thickness of the first building component such that said transition zone is aligned with a joint between the first and second building components,
wherein said transition zone includes multiple longitudinal ribs that are circumferentially spaced about said transition zone,
wherein said lower shank portion includes a plurality of lower retention rings that increase in diameter moving toward said transition zone.

4. The fastener as set forth in claim 3, wherein said upper shank portion includes a plurality of upper retention rings that increase in diameter moving toward said head.

5. The fastener as set forth in claim 3, wherein said upper shank portion is smooth.

6. A fastener for securing a first building component to a second building component, said fastener comprising:
a head having a head diameter;
a shank connected to said head, said shank having a shank diameter that is less than said head diameter;
said shank extending along a longitudinal axis to a tip;
said shank including an upper shank portion adjacent said head, a lower shank portion adjacent said tip, and a transition zone positioned longitudinally between said upper shank portion and said lower shank portion; and
said transition zone being longitudinally spaced from said head by a pre-determined distance that is associated with a thickness of the first building component such that said transition zone is aligned with a joint between the first and second building components,
wherein said shank includes an anti-rotation portion positioned longitudinally between said lower shank portion and said transition zone.

7. The fastener as set forth in claim 6, wherein said shank includes a frangible break-away connection between said anti-rotation portion and said transition zone.
